(19) United States
(12) Patent Application Publication
(10) Pub. No.: US 2022/0228710 A1
(43) Pub. Date: Jul. 21, 2022

(54) GRAVITY COMPENSATION MECHANISMS AND METHODS

(71) Applicant: VIRGINIA TECH INTELLECTUAL PROPERTIES, INC., Blacksburg, VA (US)

(72) Inventors: Alan Asbeck, Blacksburg, VA (US); Andrew Bolkhovitinov, Reston, VA (US)

(21) Appl. No.: 17/608,060

(22) PCT Filed: Mar. 20, 2020
(86) PCT No.: PCT/US20/24000

§ 371 Date: Nov. 1, 2021

Related U.S. Application Data
(60) Provisional application No. 62/841,958, filed on May 2, 2019.

(51) Int. Cl. F16M 13/04; B25J 9/00; B25J 9/10

(52) U.S. Cl. CPC F16M 13/04; B25J 9/10; B25J 9/0006

(57) ABSTRACT

Mechanisms and methods for providing gravity compensation to an arm or an arm holding a tool, that allows that arm to seem weightless. The mechanisms and methods include pantograph members that mimic the kinematics of the arm and also compensate for gravity making the arm, the arm holding a tool, or a tool seem weightless.

### FIELD OF THE INVENTION

The present invention relates to mechanisms and methods for providing gravity compensation to a human or robot, such as to an arm thereof, that supports the weight the arm, and optionally also a tool held in the hand of the arm, against gravity, independent of the arm's kinematic configuration.

### BACKGROUND

Workers lifting heavy objects, particularly repeatedly, are often prone to injuries. And some individuals cannot or have trouble lifting their own arm which limits their ability to perform simple activities of daily living and carry objects. Humanoid robots often require large or numerous motors to operate such as when lifting payloads. Therefore, a need exists for mechanisms and methods that offload the weight of the arm and or objects held by the arm.

### SUMMARY

Accordingly, the present invention may provide a gravity compensation mechanism for an arm, an arm holding a tool, or a tool that comprises a pantograph member configured to mimic the kinematics of the arm, the pantograph member may comprise a first point that is a support point for supporting the arm, the arm holding the tool, or the tool, a second point that is an upward force point where an upward force is applied to the pantograph member, and a third point that is a downward force point where a downward force is applied to the pantograph member, the first, second, and third points being axially aligned with one another along an arm balancing line. The second point is between first and third points such that torque is created in the pantograph member which transfers lift to the first point against gravity.

In certain embodiments, the gravity compensation mechanism further comprises a first force element coupled to the pantograph member at the second or pantograph point and a second force element coupled to the pantograph member; the first and second force elements may be passive elements; one or both of the first and second force elements can comprise a spring element; the first and second force elements can be coupled to the pantograph member at upper ends thereof, respectively; the first force element comprises a spring member that applies the upward force; the spring member can be a gas spring, a leaf spring, or a spring biased post; the second force element comprises a vertical connector; the vertical connector is a spring element, rod, beam, cable, or cord that applies the downward force to the second or pantograph point; each of the first and second force elements is coupled to a user's body associated with the arm via an attachment device; the attachment device can be a strap, belt, band, or harness; and/or the first force element is coupled to the user's body at a lower end remote from the second point of the pantograph member.

In other embodiments, the pantograph member comprises at least a main link, a forearm link, a connector link, and a fourth link connecting the forearm and connector links, the links can be configured to pivotally cooperate with one another to mimic the kinematics of the arm; the second point can be located at or near an end of the connector link opposite a pivot connection of the connector link with the fourth link, the third point is located at an end of the main link opposite a pivot connection of the main link with the forearm link, and the first or support point is located on the forearm link, and wherein the connector link is pivotally connected to the main link; the links of the pantograph member can be bars, beams, cables, or combinations thereof; the links of the pantograph member can be pivotally connected via pin joints, ball joints, cable pulleys, or combinations thereof; the first force element can be coupled to the connector link and the second force element is coupled to the main link at the fulcrum point; the first force is a spring member that applies the upward force and the second force is vertical connector that applies the downward force; the pantograph member includes one or more vertical risers at one or both of the second and third points; an arm cuff may be coupled to one or both of the main and forearm links, or the fourth link instead of the main link; and/or the first and second force elements can be coupled to the pantograph member by a ball joint, roll-pitch-roll joint, roll-pitch-yaw-roll joint, or hinge joint.

In some embodiments, the gravity compensation mechanism further comprises a second pantograph member that comprises links configured to pivotally cooperate with one another to mimic the kinematics of the arm; a U-shaped connector piece can be used to connect the two second points and connects the two third points of both pantograph members; the first and second force elements can be coupled to each of the U-shaped connector pieces, respectively; the force elements can be coupled to a rocker bar opposite the U-shaped connector pieces; one or more of the links can have an adjustable length; the vertical connector is coupled to the main link via a Y-fork rotational joint configured to facilitate shoulder roll motion; and/or a motor can be coupled to one or both of the first and second force elements.

The present invention may further provide a gravity compensation member for an arm, an arm holding a tool, or a tool, that comprises a pantograph member that comprises a plurality of joints that are configured to pivotally cooperate with one another to mimic the kinematics of the arm or of the arm holding a tool, a pulley defining one or more of the joints, and one or more cables operatively coupled with each of the pulleys, and the pantograph member defining a first or support point for supporting a forearm of the arm or arm holding a tool, a second or pantograph point, and a fulcrum point associated with a rotation of a shoulder of the arm, and the support, fulcrum, and pantograph points being axially aligned with one another along an arm balancing line or a tool balancing line. An upward force can be applied to the pantograph point and a downward force can be applied to the fulcrum point, thereby creating torque in the pantograph member that transfers an upward support force to the support point to compensate for gravity and lift the arm or the arm holding a tool, or the tool itself.

In other embodiments, the pantograph member comprises at least a shoulder lift link or beam, a curved elbow link or beam, and a forearm link or beam pivotally coupled to one another via the joints; the one or more cables can be operatively coupled to that curved elbow link or beam and the shoulder lift link or beam via the pulleys; the curved elbow link or beam and the shoulder lift link or beam can be coupled to another by a rotational block; the forearm link includes a tool attachment at a distal end thereof; the second force element is a vertical beam coupled to the should lift link or beam by a y-fork rotational joint; the links or beams of the pantograph member define an axis of rotation for shoulder abduction/adduction, an axis of rotation for shoulder rotation, an axis of rotation for shoulder flexion/extension, an elbow rotation axis, and a forearm roll axis; each of the first and second force elements is coupled to a body associated with the arm via an attachment device; the attachment device can be a strap, belt, band, or harness; a motor can be coupled to the first force element; and/or a motor can be coupled to one or more of the joints of the pantograph member.

The present invention may yet further provide a method of providing gravity compensation to an arm, an arm holding a tool, or a tool comprising the steps of: donning a pantograph mechanism on a user, the pantograph mechanism comprising a pantograph member configured to mimic the kinematics of the arm of the user, the pantograph member comprising a first point, a second point, and a third point, the first, second, and third points being axially aligned with one another along an arm balancing line; and applying an upward force to the second point and applying a downward force to the third point, thereby creating torque in the pantograph member that transfers lift to the first point against gravity to support the weight of the arm of the user, the arm of the user holding a tool, or the tool.

In certain embodiments of the method, the force elements coupled to the second and third points, respectively, apply the upward and downward forces to the pantograph member; at least one of the force elements is a spring member that applies the upward force to the pantograph member; at least one of the force elements is a vertical connector that applies the downward force to the pantograph member; the pantograph member can comprises a plurality of links that are pivotally connected one another; and/or the pantograph member can comprises one or more pulleys defining one or more joints between the links.

In an embodiment, the method further comprises the step of varying the direction of the force on the pantograph member to allow the user to tilt forward or backward.

### BRIEF DESCRIPTION OF THE DRAWINGS

FIG. 1 is a front view of a gravity compensation mechanism and method according to an exemplary embodiment of the present invention, showing the mechanism worn by a person;

FIGS. 2A-2C are side diagram views of the mechanism illustrated in FIG. 1, showing movement of the mechanism that follows the kinematics of an arm;

FIGS. 3A-3D are various perspective views of the mechanism illustrated in FIG. 1;

FIG. 4 is a rear view of the gravity compensation mechanism illustrated in FIG. 1;

FIGS. 5A and 5B are perspective view of the mechanism illustrated in FIG. 4;

FIGS. 6A and 6B are side views of an alternative spring element for the gravity compensation mechanism illustrated in FIGS. 1 and 4;

FIGS. 7A and 6B are front vies of another alternative spring element for the gravity compensation mechanism illustrated in FIGS. 1 and 4;

FIG. 8 is a side diagram view of a gravity compensation mechanism and method according to an exemplary embodiment of the present invention;

FIGS. 9A and 9B are side diagram and perspective views, respectively, of a gravity compensation mechanism and method according to an exemplary embodiment of the present invention, showing the mechanism;

FIG. 10 is a side diagram view of a gravity compensation mechanism and method according to an exemplary embodiment of the present invention;

FIG. 11 is a side diagram view of a gravity compensation mechanism and method according to an exemplary embodiment of the present invention;

FIGS. 12A-12C are various perspective views of a gravity compensation mechanism and method according to an exemplary embodiment of the present invention;

FIGS. 13A-13C are various perspective views of a gravity compensation mechanism and method according to an exemplary embodiment of the present invention;

FIGS. 14A-14C are various elevational views of body attachments for use with a gravity compensation mechanism;

FIGS. 15A and 15B are side diagram views of a gravity compensation mechanism and method according to an exemplary embodiment of the present invention;

FIGS. 16A and 16B are perspective views of a gravity compensation mechanism and method according to an exemplary embodiment of the present invention;

FIGS. 17A and 17B are side diagram and perspective views, respectively, of a gravity compensation mechanism and method according to an exemplary embodiment of the present invention;

FIG. 18A is a side diagram view and FIGS. 18B-18D are various perspective views of a gravity compensation mechanism and method according to an exemplary embodiment of the present invention;

FIG. 19A-19C are side diagram views of gravity compensation mechanisms and method according to exemplary embodiments of the present invention;

FIG. 20 is a perspective view of a gravity compensation mechanism and method according to an exemplary embodiment of the present invention;

FIGS. 21A-21C are various perspective views of a gravity compensation mechanism and method according to an exemplary embodiment of the present invention;

FIGS. 22A and 22B are side elevational views of the mechanism and method illustrated in FIGS. 21A-21C, showing the mechanism attached to a person's arm holding a tool;

FIG. 23 is a perspective view of gravity compensation mechanism and method according to alternative exemplary embodiments of the present invention, showing motors used with the mechanism;

FIGS. 24A and 24B are side views of an exemplary method of adjusting the force of the gravity compensation mechanism, in accordance with the present invention;

FIG. 25 is perspective views of gravity compensation mechanism and method according to alternative exemplary embodiments of the present invention, showing motors used with the mechanism;

FIG. 26 is perspective view of gravity compensation mechanism and method according to alternative exemplary embodiments of the present invention;

FIGS. 27A and 27B are side views of a gravity compensation mechanism and method according to another exemplary embodiment of the present invention, showing a method of changing force direction;

FIGS. 28A and 28B are side views of a gravity compensation mechanism and method according to another exemplary embodiment of the present invention, showing a method of changing force direction;

FIG. 29 is a side view of a gravity compensation mechanism and method according to yet another exemplary embodiment of the present invention, showing a method of changing force direction; and

FIG. 30 is a graph showing one way of generating a near-constant downward or upward force.

### DETAILED DESCRIPTION

Referring to the figures, the present invention generally relates to mechanisms and methods for providing gravity compensation to a human or robot, and preferably to an arm thereof, that allows the arm, an object held in the hand, and/or the arm holding an object plus the object itself, to seem weightless or have a reduced weight. In general, the present invention provides a pantograph mechanism that is configured to copy or mimic the motion of the human arm or a robotic arm. The pantograph mechanism may use multi-linkages, cables, pulleys, or a combination thereof for the gravity compensation. The mechanisms and methods of the present invention provide the gravity compensation while also allowing for a range of motion for the arm and being simple to construct. In the case of a person's arm, the pantograph mechanism of the present invention may comprise a light weight form-fitting exoskeleton. The present invention may provide the gravity compensation entirely with passive elements, e.g. springs, or with a combination of passive and non-passive elements, e.g. motors. If the person, or a robot, picks up an object, such as a payload or tool, the present invention provides gravity compensation for the object as well. This may be done in conjunction with one or more motors that can vary the strength of the gravity compensation to accommodate different weights of objects.

For purposes of this disclosure, the arm to be supported is composed of an “upper arm” segment and a “forearm” segment, each having its own center of mass. The kinematics of the arm include, approximately, a spherical joint at the shoulder and a pin joint at the elbow. The forearm can rotate about the axis along its length (pronation and supination, which we will referred to as “forearm roll”), and the wrist can move in two directions (flexion and extension and abduction/adduction). The arm can be approximately represented by two masses, one for the upper arm and one for the combination of the forearm and hand.

Due to the geometry of the arm, there exists a line extending radially from the shoulder and intersecting with the forearm about which the masses of the upper arm and the forearm plus hand generate equal and opposite torques, shown as the arm balancing line L. In FIG. 1, the line connecting the second or pantograph point, first or support point, and third or fulcrum point is line L, which may be coincident or nearly coincident with the line between the shoulder and forearm support point. This line L intersects the forearm at an arm support point. Note that the arm support point may be generally in the center of the forearm, close to or within the bones. To find this arm support point, the center of mass of the entire arm can be found by combining the center of mass of the upper arm and the center of mass of the forearm. If the upper arm has a mass mᵤₚₚₑᵣₐᵣₘ, and the forearm and hand have a combined center of mass of m_{forearm}, then the center of mass of the entire arm is located on a line between these two center of masses. Specifically, if the distance between these two masses is xₜₒₜₐₗ, then the center of mass of the entire arm will be located on this line a distance x from the upper arm center of mass, where

x=m_{forearm}/(mᵤₚₚₑᵣₐᵣₘ+m_{forearm})*xₜₒₜₐₗ.

The arm balancing line L passes through the shoulder, the center of mass of the entire arm, and the arm support point. The arm support point is the point where the arm balancing line L intersects the forearm.

The mechanism of the present invention may comprise three points: the first point is the support point and is where the arm or tool exerts a downward force; the second point is the upward force point where an upward force is applied to the mechanism; and the third point is the downward force point where a downward force is applied to the mechanism. The upward force point is between the downward force point and the support point. The combination of the upward force at the upward force point and the downward force at the downward force point creates a torque which serves to lift up the support point against gravity. The three points may be connected with a pantograph mechanism.

In some embodiments, the upward force point remains stationary (or relatively stationary) with respect to the body as the user moves their elbow and rotates their arm. In these embodiments, the downward force point moves to change the distance between the upward and downward force points according to the arm's kinematics.

In other embodiments, the downward force point remains stationary (or relatively stationary) with respect to the body as the user moves their elbow and rotates their arm. In these embodiments, the upward force points moves in accordance with the arm's kinematics as the user moves their elbow and rotates their arm.

Either or both of the upward force point and downward force point can move up and down vertically, to accommodate the wearer's arm motion. In some embodiments, only the upward force point moves up and down, e.g. with a gas spring, while the downward force point remains in a fixed position vertically (e.g. with a connecting rod, cable, or belt). In other embodiments, only the downward force point moves up and down, e.g. with an elastic band or cord attached to a motor on its distal (lower) end pulling downward, while the upward force point remains in a fixed position vertically, e.g. with a rigid rod. In still other embodiments, both the upward force point and downward force point can move vertically, e.g. if the downward force point is pulled downward with an elastic band and the upward force point is pushed upward with a gas spring.

By applying an upward force to the arm support point to support the weight of the arm (the weight of the entire arm and hand minus the upward force provided by the shoulder), the arm will be balanced. The arm will be balanced independent of its rotation about the balancing line L because the upper arm and forearm plus hand masses will still generate equal torques about the line L. In the limit, if the forearm is held vertically, then both masses will be either above or below the balancing line L. Additionally, the arm support point remains in the same position independent of the elbow angle. In one example, if the elbow forms a 180 degree angle (i.e. is straight), then the upper arm mass and forearm plus hand mass will both be in line with the balancing line L. Therefore, an upward force at the arm support point balances the arm independent of its kinematic configuration, and the required force at that point can remain constant or near constant as well. Even if the elbow is moved to a different angle, the arm balancing line L still passes through the center of mass of the entire arm (m_{wholearm}) as well as the arm support point.

If a person holds an object in their hand, such as a box they are lifting or a tool, then that object (hereinafter referred to as a “tool”) also has a balancing line and support point. Because the tool has a single point mass, the tool balancing line TL extends from the shoulder to the center of mass of the tool, and the tool support point is located at or near the center of mass of the tool. The center of mass of the tool may be in line with the forearm or it may also have some offset from the hand. For example, the center of mass may be above and in front of the hand, such as by as much as 10-20 centimeters, if the tool has a handle. For example, a tool such as a drill has center of mass that is located above and forward from the hand grip, as seen in FIGS. 22A and 22B.

In an exemplary embodiment, the present invention may provide a pantograph member 100 that is designed to create an upward force at the arm support point (or at the tool support point) to follow the kinematics of the arm, as seen in FIGS. 1 and 4. The pantograph member 100 may be configured to create a pantograph arm that generally follows the same kinematics as the human arm, the same kinematics of an exoskeleton structure that moves with the human arm, or is the structure of a robot arm. The pantograph member 100 may be configured to have a support point SP that generally coincides with and mirrors the motion of the arm support point on the human arm or on a robot arm. The pantograph member 100 transfers forces from the support point and fulcrum point to the support point, which then creates an upward force at the support point SP. In this manner, that force can be transferred from the arm of a person or robot (and optionally with a tool or payload) to a grounded support structure or to the wearer's body, as seen in FIG. 1, thereby providing gravity compensation for the arm, so that the user or robot will not have to support the weight of their arm or tool i.e. the arm or arm holding a tool seem weightless or have a reduced weight.

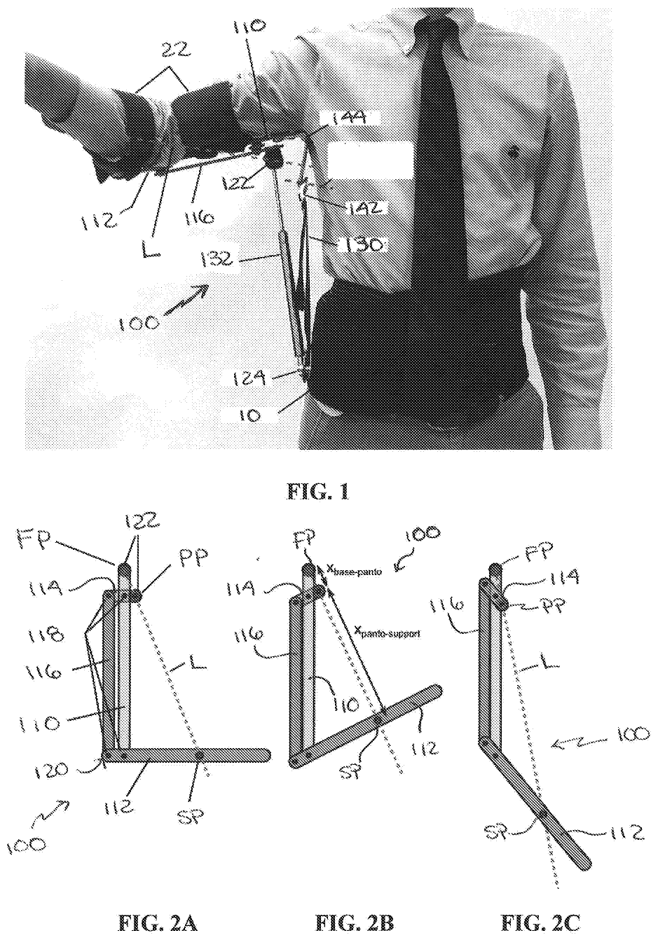

In one embodiment, the pantograph member 100 may be a multi-bar linkage, such as a four-bar linkage, as seen in FIGS. 2A-2C. The user may wear the pantograph member 100 in the form of an exoskeleton. The multi-bar linkage may comprise a main link 110, a forearm link 112, a connector link 114, and a fourth or four-bar link 116 connecting the forearm and connector links 112 and 114, thereby effectively creating a lever (e.g. class 3 lever), to support the user's arm. The links may be pivotally connected, such as via pin joints 118. In this embodiment, the pantograph member 100 defines the second or pantograph point PP that is located between the third or fulcrum point FP and the first or support point SP. The fulcrum point FP (the third point) may have a downward force applied on it and is preferably co-located with the shoulder's center of rotation. The fulcrum point FP may also be offset from the shoulder's center of rotation due to the radius of the shoulder joint and tissue surrounding it. The pantograph point PP (the second point) may have an upward force applied to it. The user's arm pushes down on the support point SP. The downward force at the fulcrum point FP and the upward force at the pantograph point PP creates torque sufficient to transfer an upward support force to the support point SP. Alternatively, the fulcrum point FP may be the second point with an upward force applied thereto and the pantograph point PP may be the third point with a downward force applied thereto to create the torque. The main link 110 may be aligned (or close to aligned) with the user's upper arm, and the forearm link 112 may be aligned (or closely to aligned) with the user's forearm and the connection 120, such as via pin joint 118, between them may be aligned (or closely aligned) with the user's elbow joint. If the location of the support point SP is projected into the plane of the linkage, it can lie close to the forearm link 112. The multi-bar linkage of this embodiment may be a parallel four-bar linkage, for example, which is configured to copy or mimic the actual arm kinematics to the pantograph point PP, or it could be slightly off from parallel and still function substantially the same way.

With the four-bar linkage pantograph member of this embodiment, the pantograph point PP moves closer to the fulcrum point FP as the elbow angle decreases, as seen in FIG. 2B (the distance between the fulcrum point FP and pantograph point PP is denoted x_{base-panto} and the distance between the pantograph point PP and support point SP is denoted xₚₐₙₜₒ₋ₛᵤₚₚₒᵣₜ. With the four-bar linkage of this embodiment, the ratio between these distances is a constant or substantially constant, as seen in FIGS. 2B and 2C. This allows for a constant or near constant upward force at the pantograph point PP to balance the arm independent of elbow angle. In an embodiment, joints 122, such as ball joints, are located at the pantograph point PP and fulcrum point FP, as seen in FIG. 2A. With ball joints, the entire pantograph linkage member 100 is free to rotate around the arm balancing line L. Thus, a constant or near constant upward force is provided to the support point SP independent of the arm's configuration. The multi-linkage of this embodiment can have N-links and/or can be combined with cables to create the pantograph mechanism. Hard stops can be included with the pantograph member 100 to prevent the arm from extending or flexing beyond a desired range.

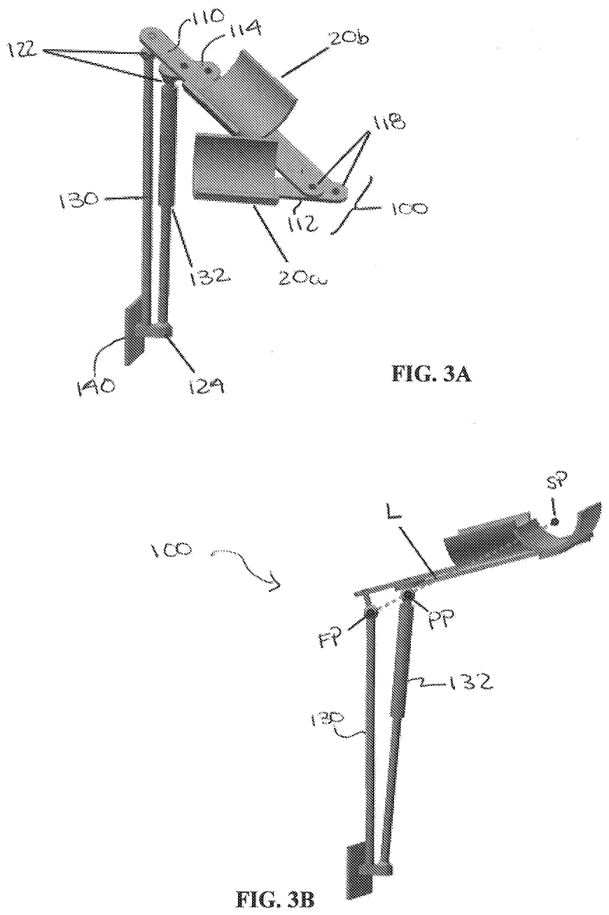

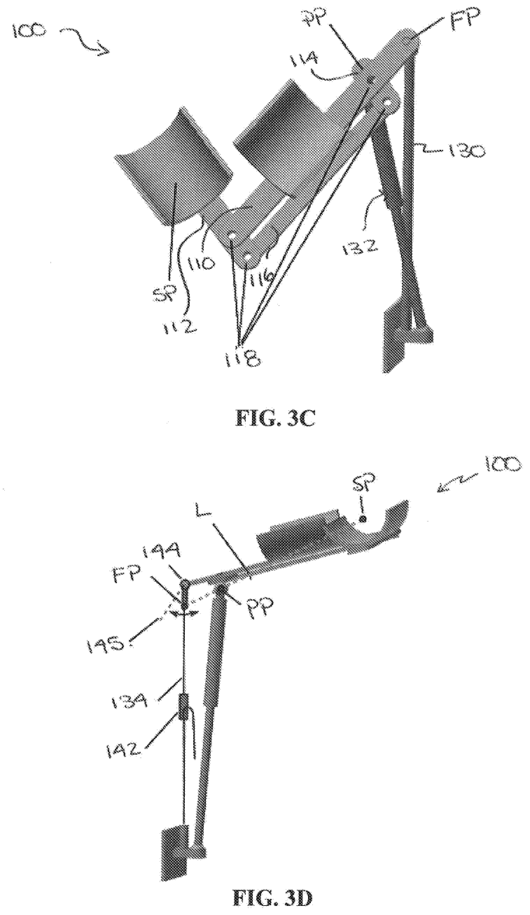

Referring to FIGS. 3A-3D, the pantograph member or four-bar linkage 100 can be connected at the fulcrum point FP via joint 122 to a force element 130, e.g. a vertical connector, e.g. a rod or the like, that generates a downward force, and the pantograph point PP may be connected via joint 122 to another force element 132, e.g. a spring element, like a gas spring or the like, that generates an upward force. The lower ends of both of the vertical connector 130 and the gas spring 132 may be connected to a fixture 140 that attaches to the wearer's body, such as to waist belt 10 (FIG. 1), for example. Both of the vertical connector 130 and the gas spring 132 may have joints 124 where they connect to the fixture 140, e.g. ball joints, which permit them to rotate about a vertical axis as the shoulder moves in horizontal abduction and adduction direction, or to tilt in other directions if the user bends their torso. Also connected to the four-bar linkage 100 may be one or more cuffs for the upper arm and forearm. The cuffs 20 may have straps 22 (FIG. 1) to wrap around the user's upper arm and forearm.

The fulcrum, pantograph, and supports points preferably lie along the arm balancing line L, i.e. they are axially aligned along balancing line L, as seen in FIG. 3B. The support point SP may be located in the center or near the center of the user's arm some distance above the parallel four bar linkage, and the fulcrum point FP may be located below it in such that the three points align. Also, even if the plane of the four-bar linkage is not co-planar with the plane of the user's arm (i.e. perpendicular to the elbow joint axis), such does not affect the balancing properties of the gravity compensation mechanism of the present invention.

In the present invention, the force mechanism or vertical connector 130 can be a beam, bar, or the like, or can be cable, cord, or the like. In the case that the vertical connector 130 is a cable or cord, no ball joint would be needed because the cable or cord could flex to keep the downward force on the fulcrum point. Also, as shown, the spring element 132 and the vertical connector 130 may both attach to the fixture 140 connected to the waist belt 10 of the wearer. In an alternative embodiment, one or both of the spring element 132 and the vertical connector 130 may be connected to an intermediate piece, where the intermediate piece is attached to either the bottom of the spring element 132 or to the vertical connector 130, and the intermediate piece can be attached to the waist belt, via an attachment device, such as a ball joint, underneath it. In an embodiment, this intermediate piece could be elongated such that the spring element 132 extends about halfway to the waist, for example, with the intermediate piece extending the rest of the way to the waist belt 10.

The force element or spring element 132 may be used to provide a constant or near constant vertical force on the pantograph point PP of the pantograph member 100. Other mechanisms could be used instead of a gas-spring for the spring element 132, which provide a near-constant vertical force. For example, a thin beam of carbon fiber, fiberglass, or other material acting as a leaf spring 132′, as seen in FIG. 6A, can produce a near-constant force when placed in bending, as seen in FIG. 6B. The leaf spring 132′ may be pre-bent through a cord 134′ connecting the two ends. Also, ball joints 122′ and 124′ may be attached to each end of the leaf spring 132′, which may be angled with respect to the leaf spring using a standoff 123′. When the two ball joints 122′ and 124′ of the leaf spring are moved toward each other, the leaf spring 132′ can bend further, providing a restoring force, thereby causing the cord 134′ to become slack. Also, because the ends of the leaf spring 132′ can rotate via joints 122′ and 124′ as it bends, the angled standoff 123′ allows the ball joints to maintain a favorable orientation with respect to the rest of the pantograph member exoskeleton.

In an embodiment, the vertical connector 130, the spring element 132, the leaf spring 132′, or any other disclosed force element can be held in a bent position by having a buckle 142 on a strap 134 (FIG. 3D) such that when the buckle 142 is tightened, the length of the strap or cord 134 is shortened. This will cause, for example, the vertical connector 130 or the effective length of the carbon fiber beam of the leaf spring 132′ to shorten. If the spring element (for example 132 or 132′) is shortened and then a strap between its ends is tightened, this can be used to effectively disengage the pantograph exoskeleton mechanism so it can be easily donned or doffed. One way to tighten the strap or cord 134 is if the exoskeleton user first lowers their arm, which will cause the spring element to be compressed. Then, the slack can be removed from the strap or cord 134 while it is not under tension, and it will stay compressed if the user removes the exoskeleton.

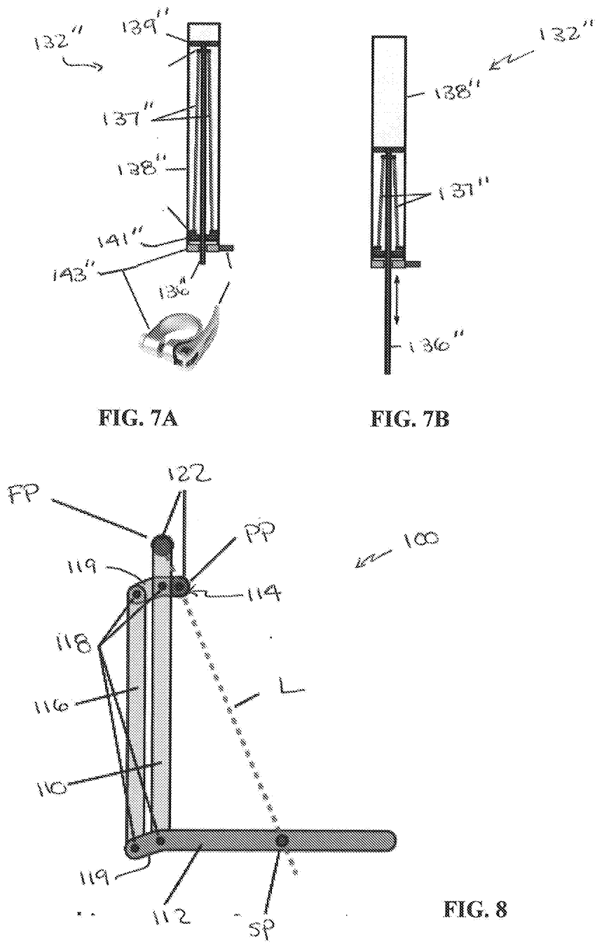

Another possible force element 132″ that can be used instead of a gas spring is illustrated in FIGS. 7A and 7B. In this embodiment, a central post 136″ can move in and out of an outer cover 138″. The central post 136″ can be held in the center of the outer cover with a bushing 139″ attached to its top end, which can slide along the inside of the outer cover, and a bushing 141″ attached to the opening at the lower end of the outer cover, through which the central post can slide. Attached to the lower end of the outer cover 138″ and the top end of the central post 136″ can be one or more spring elements 137″, such as natural gum rubber or traditional extension springs, which bias the central post 136″ outward from the outer cover 138″. These springs elements 137″ can be pre-tensioned in order to achieve a more constant force from the assembly. An optional way of fixing the force spring element is with a clamp 143″ mounted on the lower end of the outer cover. This clamp 143″ can be closed to grip the central post 136″. When the clamp 143″ is closed, the central post 136″ is prevented from moving with respect to the outer cover 138″, so the pantograph member exoskeleton will not spring open unintentionally. This also can make it easier to don and doff the exoskeleton.

One way of securing the exoskeleton in a fixed position for donning and doffing is to use a clip between the four bar-linkage 100 and the spring element 132, vertical connector 130, or waist belt 10. A clip could be mounted on the spring element, vertical connector, or waist belt 10, and a loop could be present on the linkage at the underside of the arm, for example close to the elbow. When the user lowers their arm down, they can secure the loop to the clip. This would prevent the exoskeleton arm from raising.

Also, as an alternative to a rigid bar, cord, or webbing strap as the vertical connector or force element 130 (applied to the fulcrum point), a second gas spring or other type of spring can be used, which provides the compressive downward force. This can be accomplished by, for example, an elastic strap, a piece of rubber, a metal extension spring connected to a cord, or the like. The downward force on the fulcrum point FP is independent of the configuration of the arm. Thus, having a constant-force spring (or near-constant force spring) creating a downward force on the fulcrum point FP can allow the entire pantograph mechanism 100 to translate up and down. This can be beneficial if the user shrugs their shoulders, for example, or if they bend their back to the side. Also, in the event that there is a kinematic difference between the user's shoulder's rotation point and the fulcrum or pantograph point, the fulcrum and pantograph points FP and PP may need to translate up and down as the arm moves. With constant-force or near-constant-force springs 130 and 132 at both the fulcrum and pantograph points FP and PP (pulling down and pushing upward, respectively), this torque motion can be accomplished without hindering the user's motion.

Referring to FIGS. 3D, 4, 5A and 5B, in an embodiment of the present invention, a hinge 144 may be used to connect the fulcrum point FP to the main link 110, or for connecting the pantograph point PP to the connector link 114. The hinge 144 may be in the plane of the four-bar linkage mechanism, and the fulcrum point FP can be located on the part of the hinge 144 that is free to rotate. The webbing strap 134 can be connected to the end of the hinge 144 (at the fulcrum point FP), via a grommet, for example, so that it can rotate in the direction perpendicular to the hinge's plate. The hinge 144 defines a hinge axis 145 and is configured to allow the pantograph mechanism 100 to fold up more compactly when the user's arm is held vertically downward. The hinge 144 can reduce the moment arm when the user's arm is either above or below a horizontal position. This may be beneficial to reduce the torque on the arm when the arm is held by the user's side. A buckle 142 (FIG. 4) may be provided on the webbing strap (which acts to put a downward force on the fulcrum point), for adjusting the length of the webbing strap 134, which in turn can adjust the height of the device for different heights of user. The buckle 142 could be connected to the lower part of the hinge 144. The buckle 142 could be connected with a pin joint or the like which allows the buckle 144 and webbing strap 134 to rotate relative to the hinge 144. In an embodiment of the pantograph mechanism using the hinge 144, the pantograph point PP may be located at the underside of the four-bar linkage, as opposed to being at the connector bar 114 between the main link 110 and the fourth or four-bar link 116, as seen in FIGS. 3D and 4.

Referring to FIG. 4, in this embodiment, the buckle 142 can be used to effectively disengage the mechanism 100, if the webbing strap 134 is overextended. In this case, the spring element 132 can extend to its maximum length, and then no torque will be applied to the mechanism 100 because there is no downward force from the webbing strap 134 (due to it being overextended). Also, straps 22 or plastic pieces may be provided that comprise part of the arm cuffs 20a and 20b, which are connected to the main link 110 and the forearm link 112. A piece of textile may be stretched over each of these plastic pieces, providing a soft interface for the wearer.

As seen in FIG. 4, the lower ball joint 124 at the bottom of the spring element 132 may be used to connect to the user's waist belt 10, with an optional piece of plastic with foam being positioned on the side toward the user. Both this piece of plastic and foam may be embedded in the waist belt 10. This helps distribute the force over a larger area on the wearer's waist, and the foam helps provide additional cushioning.

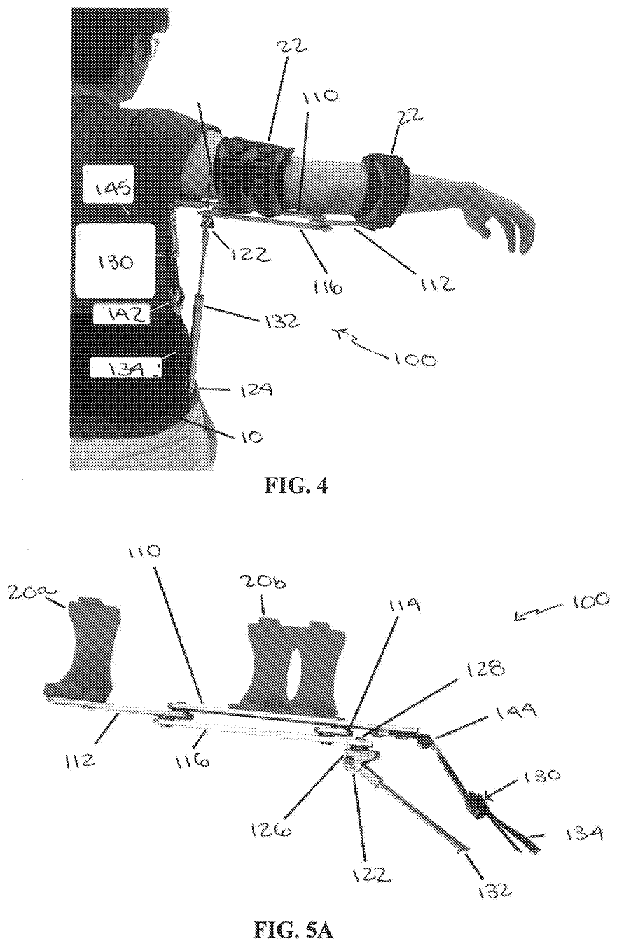

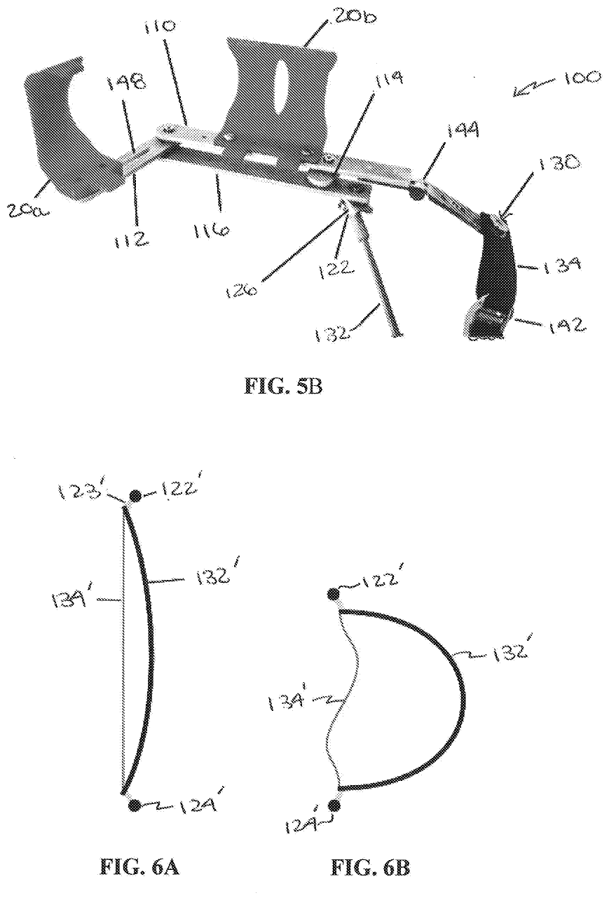

As seen in FIGS. 5A and 5B, the spring element 132 may connect via ball joint 122 at its upper end to a bracket 126 which in turn connects to the four-bar linkage through a pivot or pin joint 128. This pin joint may be the yaw portion of a roll-pitch-yaw joint connecting the spring element 132 to the four-bar linkage. The bracket 126 can secure the ball joint 122, for example, by extending down to either side of the ball, and a bolt may go through the ball and through the bracket. Each of the pin joints in the mechanism may be formed, for example, by a bolt passing through the two connected elements. In the portion of the mechanism 100 comprising the forearm link 112, the four-bar link 116, the main link 110, and the connector link 112, each of the joints may be comprised of a stack of radial bearings inside the link, a thrust bearing, then a second radial bearing inside the adjacent link such that there is low friction between the links. Similarly, a thrust bearing and radial bearing can connect the four-bar linkage 100 and the bracket 126 connecting to the ball joint 122 at the top end of the spring element 132. Instead of bearings, bushings could be used to reduce cost and make the device waterproof. Also, a slot 148 (FIG. 5B) may be used to connect a portion of a forearm cuff 20a to the forearm link 112. This allows the forearm cuff 20a to be adjusted for different users by sliding it along the slot 148 and tightening bolts that hold it in the slot 148.

In an embodiment, the links of the pantograph four-bar linkage 100 can be bent or angled at any point along their length. For example, as seen in FIG. 8, the forearm link 112 and connector link 114 connecting to the pantograph point PP can have corresponding angled portions 119. This biases the four-bar linkage to one side by the amount of the angle. For example, the human arm can extend to be essentially straight but when flexed has a minimum angle of around 30 degrees. If the four-bar linkage 100 is biased to one side relative to the human anatomy, then the four-bar linkage points will not all be exactly in a line even if the human arm is exactly in a line. The four bar linkage may be biased by incorporating angled portions 119 so that at either end of its range of motion, it will have an equal angle away from being in-line. For example, a bias angle of 15 degrees may be employed for the angled portions 119 of the exoskeleton.

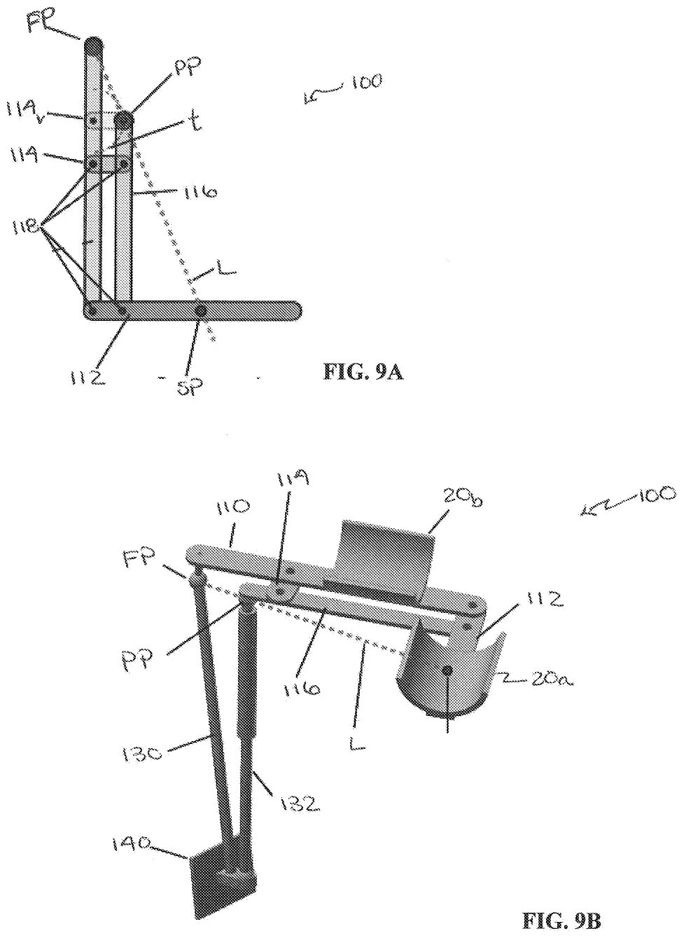

Another way of constructing the pantograph with a four-bar linkage is illustrated in FIGS. 9A and 9B. In this embodiment, the pantograph point PP may be located on the four-bar or fourth link 116. This point PP (and any point in the center of the four-bar link) follows the same trajectory t as the intersection between the four-bar or fourth link 116 and the connector link 114, shown as a “virtual link” 114, in FIG. 9A, to connect between the main link 110 and four-bar link 116. A dashed line in FIG. 9A illustrates the trajectory t of the pantograph point PP as the user's elbow bends. Placing the pantograph point PP on the main link 110, instead of on the connector link 114, may have benefits, such as the four-bar link 116 not rotating with the user's elbow, so a ball joint or other joint at the pantograph or main link 110 will not rotate but instead will translate along trajectory t as the elbow moves.

As seen in FIG. 9B, the connector link 114 and forearm link 112 can be positioned in between the main link 110 and four-bar link 116. This allows the four-bar link 116 to move to be completely underneath the main link 110 in some configurations, such as when the arm is straight. This can give the pantograph linkage a larger range of motion than other configurations.

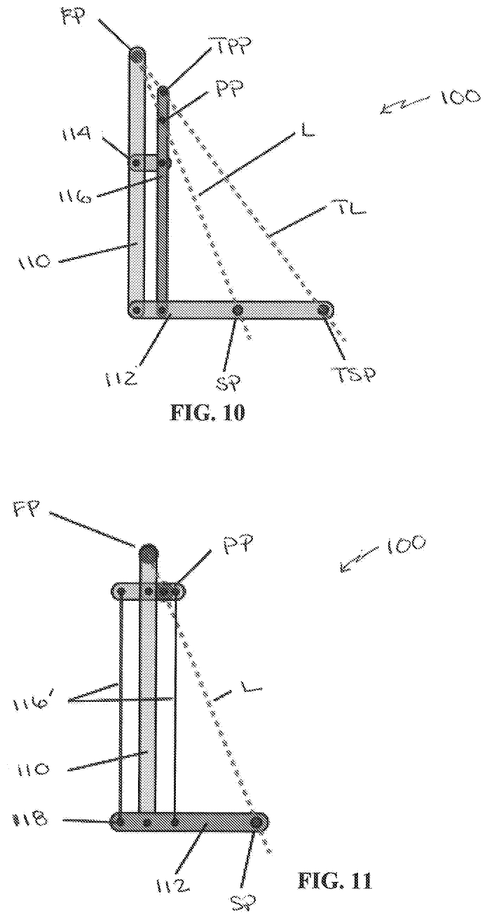

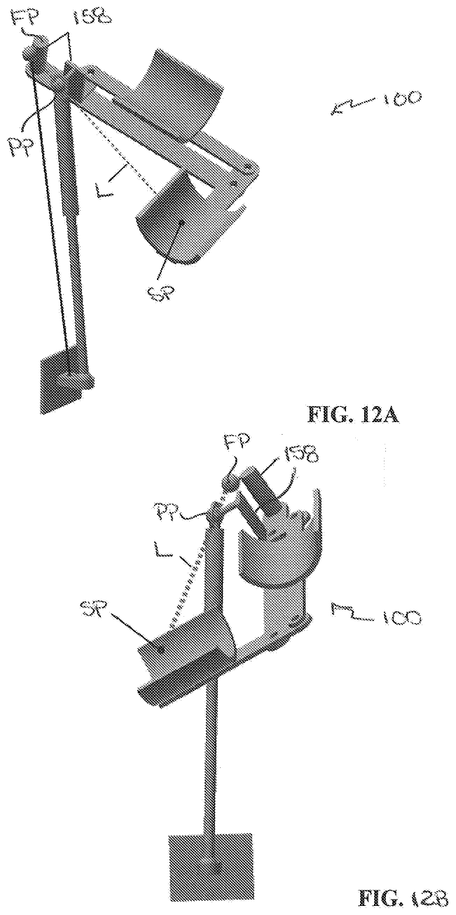

Referring to FIG. 10, in another exemplary embodiment of the present invention, the pantograph mechanism 100 can be configured to support a tool at the user's hand. In this embodiment, the tool balancing line TL passes from the fulcrum point FP through the tool pantograph point TPP and to the tool support point TSP, which is located near the user's hand. Both the arm pantograph point PP and tool pantograph point TPP are located on the four-bar or fourth link 116. Upward forces may be provided at each point, depending on the mass of the arm and mass of the tool. Downward forces may be provided at the fulcrum point FP. Both the tool and arm pantograph points TPP and PP have the same kinematics in that the points move in arcs depending on the user's elbow angle. However, the pantograph ratio (that is, the ratio of the length between the fulcrum point FP and support point TSP to the length between the fulcrum and pantograph points FP and TPP) for the tool pantograph point TPP is preferably larger than that of the arm pantograph point PP.

In this embodiment, a single upward force may be initially applied to the pantograph member at the arm pantograph point PP. A slot (similar to slot 148 in FIG. 5B) may be provided on the four-bar or fourth link 116, with one end of the slot at the arm pantograph point PP and the other end at the tool pantograph point TPP. If the user puts on the pantograph member exoskeleton without holding a tool, the upward force (e.g. via the gas spring 132) would be secured in the slot at the location of the arm pantograph point PP such that the user's arm would be balanced. Then, if the user picks up a mass (e.g. tool) in their hand, the center of mass of the user's entire arm plus mass in their hand is now in a new location that is somewhere between the arm balancing line L and the tool balancing line TL. Thus, the force element 132 (and the spring force thereof) can be slid in the slot of the link 116 toward the tool pantograph point TPP until the user's arm is properly balanced. This location is preferably on the line connecting the fulcrum point FP and the center of mass of the entire arm plus mass in hand. This adjustment of the upward spring force can be accomplished manually, or with a motor or the like. If the same force element, e.g. gas spring, is being used to support a larger mass than it was originally, the gravity compensation force will be smaller. To compensate for this, a larger spring may be used (i.e. the spring can be adjusted to have a larger force).

Alternatively, instead of the slot in link 116 between the tool pantograph point TPP and the arm pantograph point PP, there could be a series of holes along the four-bar link 116 or in a grid attached to the link 116. The force element or spring element 132 generating the upward force can be moved to the different holes to balance the arm and mass of a tool. Different holes can be used to properly adjust the pantograph exoskeleton for different users who may have different mass distributions, with or without a tool. If the user picks up a tool or other mass at their hand, the same spring element 132 can be used to compensate the mass of the arm plus tool by moving to a hole with a larger radius. Because the radius is larger, the pantograph ratio changes so that the same upward force can compensate for a larger mass of the arm plus tool.

In another variation of this invention, the pantograph member 100 can incorporate cables. For example, cables 116′ can be provided that connecting the forearm link 112 and the connector link 114, as seen in FIG. 11. The cables 116′ may be positioned and each end of the connector link 114, respectively, and on either side of the main link 110, thereby acting as the fourth link of the pantograph. One or the other of the cables 116′ will be in tension depending on the user's elbow's motion. This mechanism may lead to a lighter structure than having a rigid link creating a four-bar linkage and pantograph.

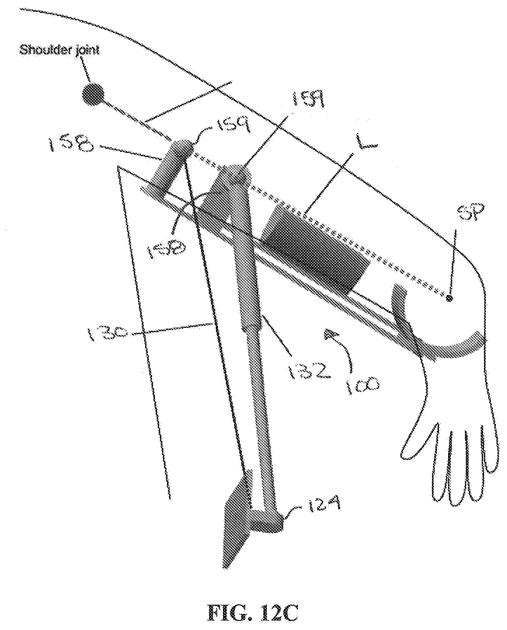

The links of the pantograph member 100 may straight bars or beams, or they may have jogs or bends in three dimensions. This could be useful for positioning the forearm link 112 underneath the user's forearm, but the proximal part of the four-bar linkage behind the user's arm. For example, one or more vertical risers 158 may be connected to the links of the pantograph member 100, as seen in FIGS. 12A-12C. This puts the arm balancing line L roughly level with the user's shoulder joint's rotation axis, when viewed from the front of the body. The majority of the pantograph linkage lies underneath the user's arm, but the risers 158 permit the fulcrum point FP and pantograph point PP to be higher. This allows the arm balancing line L to be better aligned with the user's shoulder joint, which can lead to smaller unwanted torques or exoskeleton motion when the user moves their arm.

FIG. 12C illustrates the outline of a human user, showing how, when viewed from the front, the arm balancing line L is close to being in-line with the shoulder roll (internal/external rotation) axis when risers 158 are used. The risers 158 may be coupled to the extension force elements via joints, such as ball joints 159. The ball joints 159 can be configured to move in a full range of motion if the user lifts their arm in abduction or adduction. If the user wishes to move their arm in flexion or extension, the extension force or spring element 132 can rotate around the ball joint 124 at the bottom of the spring element. Thus, the ball joints 159 and its orientation approximately implements a roll-pitch-roll joint between the spring element 132 and the four bar linkage 100. The ball joints 159 there may be used instead of a roll-pitch-roll joint, and it will not have a singularity if the upper arm is vertical. In that case, a small amount of motion will be possible with the ball joint 159 in any direction, e.g. rounded edges of a ring of the ball joint 159 will push the spring element 132 to rotate around its axis as needed.

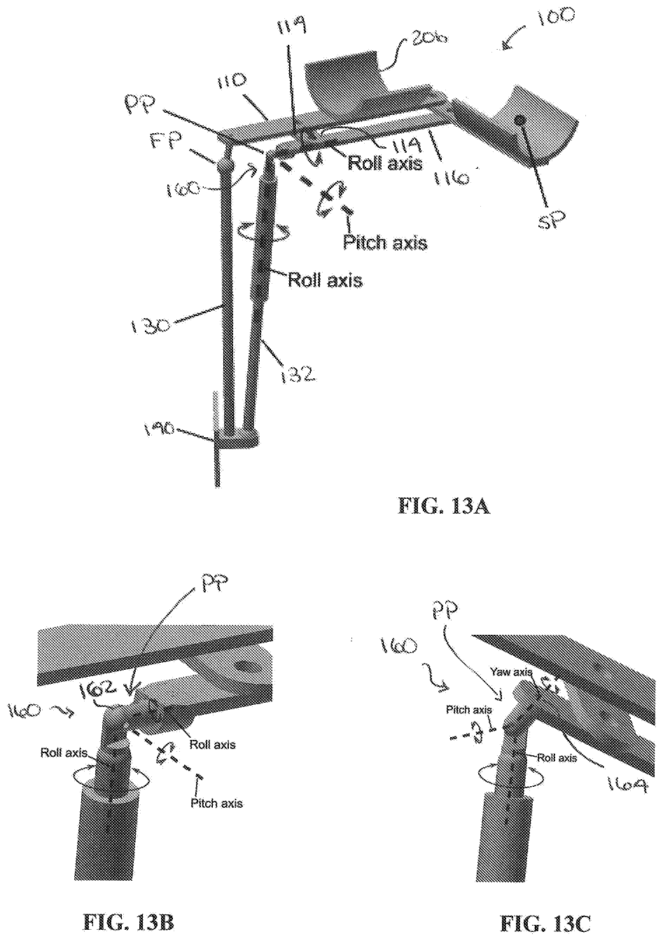

Any of the embodiments of the pantograph mechanism 100 of the present invention may incorporate one or more roll-pitch-roll or roll-pitch-yaw-roll joints 160, as seen in FIGS. 13A-13C, such as instead of a ball joint. The roll-pitch-yaw-roll joint can be used, for example, for connecting the spring element 132 to the connector link 114 of the four-bar linkage mechanism. The pitch joint 162 may be comprised of a ball joint, for example, which permits 360-degree rotation in the pitch direction but also permits smaller rotations in the other two directions in addition to the pitch direction. The use of a ball joint as the pitch joint 162 can help to prevent singularities in the mechanism because it allows some motion in all three directions. The yaw joint 164 may be comprised of a pin joint, for example, where a bracket holding the ball joint connects to the four-bar linkage mechanism.

Also, if the connector link 114 is placed between the main link 110 and the fourth link 116 of the four-bar linkage mechanism, such that the four-bar link 116 is closest to the user's body, this can provide a full range of motion for the mechanism (180 degrees). One or more slots or holes can be cut into the center of the four-bar link and the pantograph point PP can be adjusted within this slot and then secured. This allows the specific location of the arm support point SP on the user's arm to be easily adjusted. This may be useful if, for example, different sized individuals wear the exoskeleton, with different mass distributions between their upper arm and forearm.

In an embodiment, the pantograph member 100 can have a pad (not shown) that rests against the underside of the user's upper arm, instead of having the vertical connecting bar 130 attached to the fulcrum point FP. Because the downward force needed to provide gravity compensation for the user's arm may be around 30 Newtons, this can be supported without irritation by the body. Thus, this embodiment may have an arm cuff 20b facing upward at around the fulcrum point FP, which would be near the user's armpit. The gas spring 132 would still provide an upward force, but slightly distal to this arm cuff 20. The arm cuff could be attached to the four bar linkage of the pantograph member with a ball joint or several hinges so that the arm cuff 20b does not need to rotate with the rest of the structure. An arm cuff near the armpit could also be used in conjunction with the downward force element 130, such as an elastic element, providing the downward force at the fulcrum point FP. In this case, the arm cuff 20 could share the distribution of force with the elastic element connected to the fulcrum point FP.

In general, the arm cuffs 20a and 20b on an exoskeleton of the pantograph mechanism embodiments can be mounted with bolts passing through holes on the main link 110 and/or the four-bar link 116 of the linkage of the pantograph member 100. The arm cuffs could be moved up or down the arm or could be replaced by unbolting them and re-bolting them at different locations. In this way, different size arm cuffs could be used as well for the same exoskeleton frame.

Instead of ball joints at the fulcrum point FP and pantograph point PP, other ways of permitting rotation may be provided. For example, as seen in FIGS. 13A-13C, a roll-pitch-roll joint can be used at either location, or a roll-pitch-yaw-roll joint, which is similar to the roll-pitch-roll joint but with a second pitch joint in series with the first one, and the second one is rotated 90 degrees with respect to the first one so that its axis is perpendicular to both the first pitch degree of freedom and also to the axis of the lower roll degree of freedom. In the exoskeleton, the lower roll degree of freedom may be oriented vertically, and the pitch degree of freedom would permit shoulder flexion/extension or abduction/adduction depending on which way the upper arm was pointed with respect to the body. The roll degree of freedom at the top would be aligned with the main link in the pantograph mechanism, and thus would be approximately aligned with the upper arm. This degree of freedom would permit shoulder roll (internal/external rotation). The use of a roll-pitch-roll or roll-pitch-yaw-roll degree of freedom instead of a ball joint at one or both of the pantograph point PP and fulcrum point FP can increase the range of motion provided by the pantograph member 100 exoskeleton such that the exoskeleton could more closely match the biological range of motion. The roll-pitch-yaw-roll or roll-pitch-yaw joints could be used if the arm is close to vertical, which will be near a singularity from which it may be difficult to move the arm. A roll-pitch-roll or roll-pitch-yaw joint can be used at the fulcrum point FP in addition to the pantograph point FP. If a flexible cord is connected to the fulcrum point FP, such as for providing the downward force element 130, such joints are not needed because the cord can twist and flex to accommodate all of the necessary degrees of freedom.

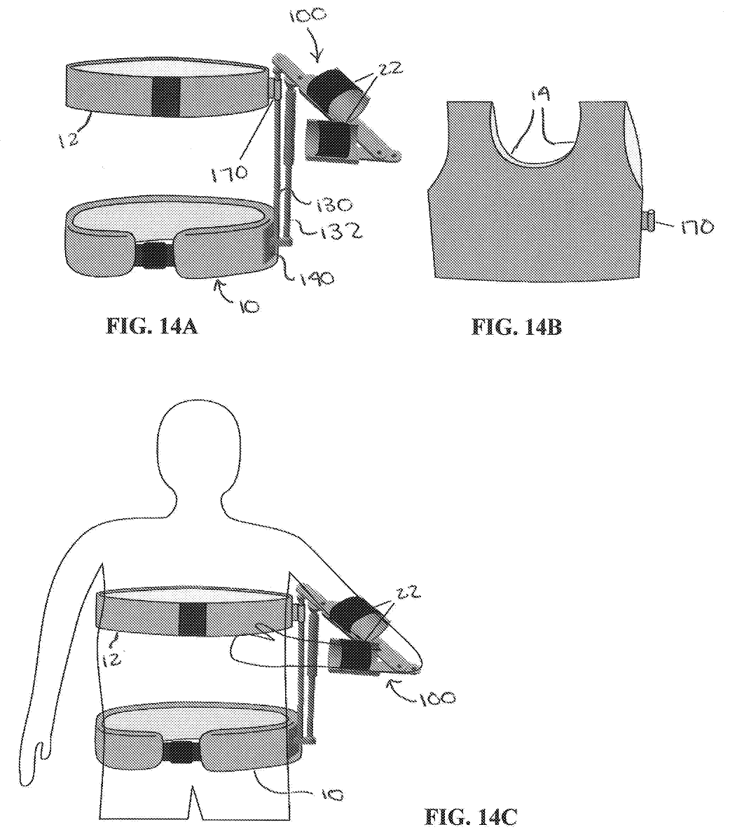

Referring to FIGS. 14A-14C, exemplary mechanisms and methods of securing the pantograph member exoskeleton linkage 100 to the user's body are shown. One or more fixtures or attachment devices 170 may be provided on the vertical connector 130 and/or spring element 132 or other force element for connecting to the waist belt 10. The waist belt may contain padding to protect the user from rigid elements in the exoskeleton. It can secure around the user's waist with a buckle or a hook and loop attachment, or the like. The top of the vertical connector 130 (or force element) can optionally be connected to a chest strap 12 or other harness going over the shoulders, as seen in FIG. 14A. The chest strap 12 could secure horizontally around the user's chest, attaching to itself with a buckle, hook and loop attachment, or the like. Alternatively, a chest harness 14, such as seen in FIG. 14B, could go over the wearer's shoulders in addition to surrounding the chest.

As seen in FIG. 14A, one or more straps can surround the user's arm 22. The arm cuffs may also be provided that could be formed of rigid materials, such as plastic or aluminum, with or without padding, such as foam, to protect the user from sharp edges or pressure concentrations. The straps 22 could extend over the tops of these arm cuffs, to secure the pantograph exoskeleton member 100 to the user's arm and keep it from lifting out of the arm cuffs. These could be secured with a buckle, with hook and loop attachment, or in any other known manner. As seen in FIG. 14B, a chest harness 14 embodiment is shown, which could be comprised of an expandable material, such as Spandex or an inextensible material such as cotton cloth, or the like. The material does not need to grip the user's chest very tightly. FIG. 14C shows how the entire system of the present invention could fit onto a human user. Although the four-bar linkage of the pantograph member 100 is shown positioned underneath the arm, the four-bar linkage could go in front of the arm or behind the arm as well, with adjustments in how the arm cuffs 20 attach to the linkage.

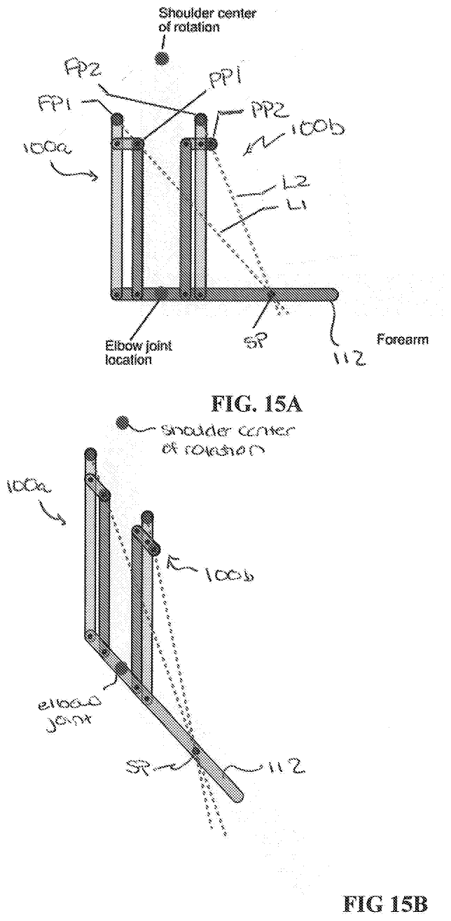

Referring to FIGS. 15A and 15B, in an alternative embodiment, the pantograph member may comprise two parallel four-bar linkages 100a and 100b, with one generally in front of the user's arm and one generally behind the arm, that may be used together to accommodate the roll of the user's upper arm. The pantograph member linkages 100a and 100b of this embodiment may share the forearm link 112, which can be elongated. Each linkage has its own pantograph point PP1 and PP2, fulcrum point FP1 and FP2, and arm balancing line L1 and L1. Each arm balancing line preferably passes through the same support point SP of the forearm link 112. FIGS. 15A and 15B show the two four-bar linkages 100a and 100b in relation to the user's shoulder center of rotation (shown by a dot at the top of each figure) and the user's elbow location (shown by a dot at the bottom left of each figure). FIG. 15B shows the configuration of the pantograph member 100 with the two linkages 100a and 100b when the elbow is extended. The two four-bar linkages 100a and 100b can remain in line between the support point SP and fulcrum points FP1 and FP2.

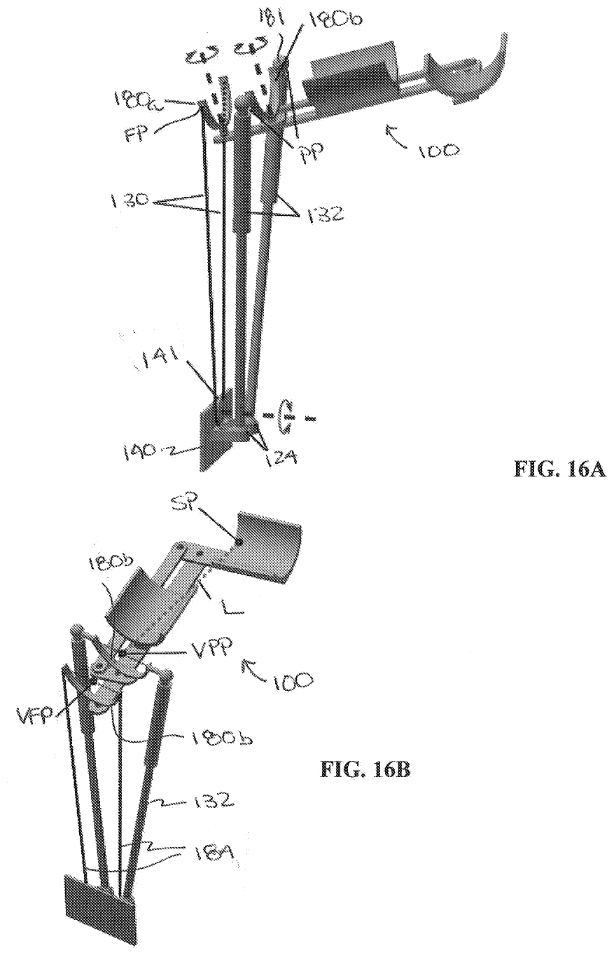

FIGS. 16A and 16B illustrate another embodiment configured to allow the pantograph member linkage to better align to the user's biological joints. In an embodiment, one or more U-shaped connectors that can connect to two vertical connectors 130 and two spring element 132, respectively 180a and 180b. The bottoms of the spring elements 132 (or other devices that provide a downward force) may be connected to a fixture, such as a rocker bar (not shown), which can be in turn is connected to the waist belt 10 through a joint, e.g. a pin or ball joint. The joints in the rocker bar may be configured to permit motion in one degree of freedom. Also, to each end of the rocker bar may be connected cables or cord or a similar tensile element, which extend to two fulcrum points FP of the pantograph member and the force elements. As the shoulder rolls (the shoulder moves in internal/external rotation), the pantograph points PP will rotate with the shoulder. In turn, the fixture or rocker bar at the bottom of the spring elements 132 can tilt back and forth to allow rotation nearly coincident with the shoulder's roll axis, if the pantograph points PP may be positioned directly in front and in back of the arm. Additionally, this embodiment allows the upper arm to move to a nearly vertical position (with the elbow downward) because there is a minimal amount of material underneath the upper arm. With this embodiment, the spring elements 132 can be on either side of the upper arm, thus enabling the upper arm to move down and be adjacent to the torso.

The U-connectors 180a and 180b may be attached to the four-bar linkage, as seen in FIG. 16A, one connected to the pantograph points PP and one connected to the fulcrum points FP on the four-bar linkage. These U-connectors 180a and 180b can be fixedly attached or they can have a rotational joint at their connection. At the U-connector 180b on top of the pantograph points PP, there may be a ball joint 181 protruding from the sides thereof. The two force elements or spring elements 132 can attach to these ball joints 181 (one on each side), and these can extend downward to a fixture, such as a plate 140, which can attach to the waist belt 10, as previously described. The spring elements 132 may connect to the plate 140 with ball joints 124 or the like. At the U-connector 180a on top of the fulcrum points FP, there may be two vertical connectors or force elements 130 connected thereto. These elements 130 could be rigid beams or bars and connected with ball joints; or these elements could be cables, webbing, flexible elements, or extension springs that can create a constant or nearly-constant force (for example, a pre-stretched piece of rubber). Inextensible cables may be used as the vertical connector 130 by passing the cables around a pulley 141 mounted at the waist; or alternatively they could connect to either end of a rocker bar mounted in place of the pulley. If vertical connectors 130 are rigid elements, they may attach to either end of a rocker bar with ball joints, such that when the arm rotates in shoulder roll, the structure is not restrained from rotating by the rigidity of the support elements.

The U-connectors 180a and 180b may be configured to create a virtual pantograph point VPP and virtual fulcrum point VFP, as seen in FIG. 16B, that are inside the user's arm. Thus, when the person rotates their arm, the virtual fulcrum point VFP could be quite close to their biological shoulder joint, thereby eliminating most of the kinematic differences between the biological arm and exoskeleton. These virtual pantograph and fulcrum points VPP and VFP may be about halfway between the sides of the U-connector 180 where the spring elements or vertical connectors 130 are attached. In this embodiment, when the shoulder rolls (internal/external rotation), one of the springs or vertical connectors 130 can shorten and the other can elongate. The cable has similarly shortened on one side but elongates on the other; this can be facilitated by the pulley 141 rotating, so the cable moves to the other side of the pulley.

Another benefit to the embodiment illustrated in FIGS. 16A and 16B, is that it could enable torso length adjustment. With a cable or webbing 184 as the vertical connector 130 with the associated pulley 141, by adjusting the total arc length of the cable 184 passing around the pulley 141, both U-joint spring elements 132 get equally compressed. To account for scapula movement, the pulley 141 may also be mounted to vertical spring-loaded linear slide system that would enable the pulley system to stretch upwards without requiring the pulley webbing/cable to be compliant itself. A constant or near-constant force spring may be used to provide the downward force on the virtual fulcrum point VFP even if the shoulder changed height. Also, so long as the webbing/cable 184 passing around the pulley 141 does not slip with respect to the pulley (for example, if it was attached to the pulley, or if instead of the pulley there was a rocker bar with the cable attached at each end), then the pivot point of the pulley 141 located at the hip may comprise a friction pivot. By adding a frictional force to the hip pulley, shoulder roll motion would be damped, which may improve the user's arm stability and controllability.

Another variant of this embodiment is to have the U-connectors 180a and 180b and the four-bar linkage member 100 positioned generally on top of the user's arm. This provides a benefit in that there are no rigid elements located directly beneath the user's arm, and thus the user can potentially have more comfort when they put their arm vertically against their side. In general, all of the embodiments of the present invention can be put on top of the user's arm instead of underneath, or could be placed behind or in front of the user's arm.

Another variant of this embodiment is to have a single force element or spring element 132 pushing upward on pantograph member at the pantograph point PP and located directly underneath the U-connector 180b and connected with the pantograph member four-bar linkage. Ball joints may be provided on the ends of the U-connector 180, which may be connected to a vertical bar on each side, which may be connected to two horizontal bars below the U-connector through pin joints. These horizontal connectors are in turn connected to the spring elements at or near their centers. This allows the U-connector to rotate, while still keeping the spring element pushing through the virtual pantograph point.

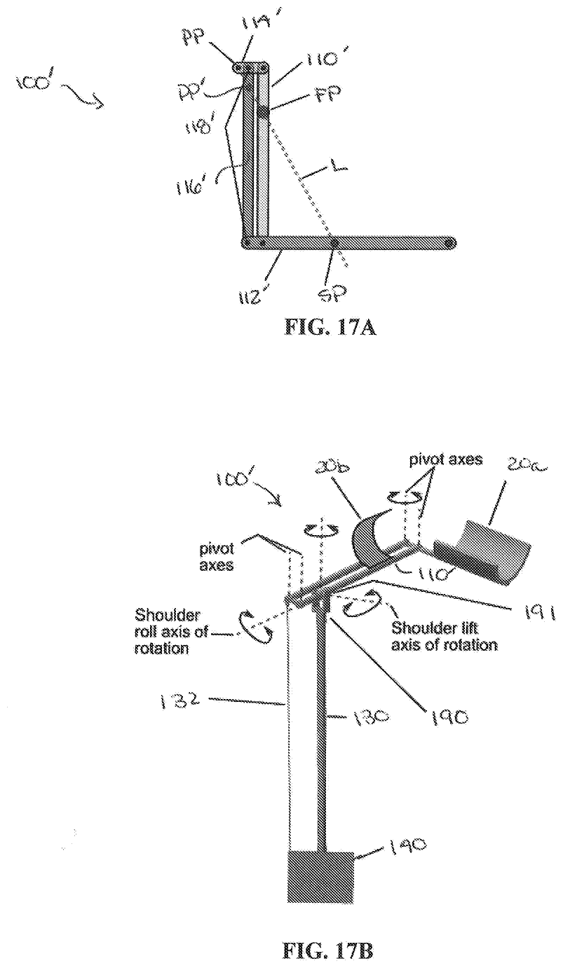

Referring to FIGS. 17A and 17B, another embodiment of the pantograph member 100′ has an intermediate fulcrum, that is its fulcrum point FP is between the pantograph point PP and the arm support point SP to create a lever, (e.g. a class 1 lever). In this embodiment, the pantograph member 100′ can be a parallel four-bar linkage that has a main link 110′, a forearm link 112′, a connector link 114′ and fourth or four-bar link 116′, pivotally cooperating such as via pin joints 118′ to create a pantograph arm that mimics the motion of a human arm or robot arm, similar to the other embodiments. As seen in FIG. 17A, the arm balancing line L aligns the pantograph point PP, fulcrum point FP, and arm support point SP. As with the other embodiments, the arm support point SP is located near or at the center of an exoskeleton user's forearm and the exoskeleton can ideally compensate for its own weight as well as the user's arm. In this embodiment, a downward force is applied to the pantograph point PP and an upward force is applied at the fulcrum point FP via force elements 130, creating torque resulting in the upward force at the arm support point SP, compensating for the weight of the user's arm and the exoskeleton's weight. Like in previous embodiments, the forces can be in reverse, that is upward force can be applied to the pantograph point PP which can be the second point with an upward force applied thereto and the fulcrum point FP can be the third point with the downward force applied thereto to create the needed torque. In the case of a robot, just the robot arm's weight is being compensated for because the exoskeleton is not needed. The connector link 114′ extending from the main link 110′ to the pantograph point PP is the pantograph arm, because it mirrors the orientation of the forearm link and is where the pantograph point is located. The portion of the main link 110′ on the pantograph side of the fulcrum point FP mirrors the motion of the upper arm.

The pantograph point PP does not have to lie on the pantograph arm or connector link 114′ but need only lie on a point that duplicates the kinematics of the forearm, which is an alternate pantograph point PP′, as identified in FIG. 17A. This moves in an arc that duplicates the kinematics of the forearm. The pantograph ratio for this point (ratio of the length between the fulcrum point and arm support point to the length between the alternate pantograph point and fulcrum point) is different than previous embodiments, in which the pantograph point is further away from the fulcrum point. Using this point as the pantograph point, the mechanism can be made more compactly.

The four-bar linkage may be comprised of round bars, for example, with slots and pin joints connecting them, as seen in FIG. 17B. Cuffs 20a and 20b may be connected to the forearm link 112′ and to the main link 110′ (which generally parallels the upper arm), to which the user's arm can attach. At the fulcrum point, a Y-fork 190 may be used that allows the main link 110′ to tilt up and down (shoulder lift, which can correspond to shoulder flexion/extension or abduction/adduction depending on if the user's arm is in front of them or to the side, respectively). Inside the Y-fork 190 is a rotational joint 191 which permits the user's shoulder roll (internal/external rotation). The main link 110′ can rotate within this rotational joint 191. Extending down from the Y-fork 190 is a vertical connector or post 130 that extends down to a fixture, such as plate 140, which can be attached to the waist belt 10, for example. The vertical post 130 of the Y-fork 190 transfers the weight of the arm and exoskeleton down to the plate 140, which subsequently transmits it to the waist. The Y-fork 190 is able to rotate around the axis of the vertical post 130 (or vertical support), either through a joint at the base of the Y-fork 190 or through the entire vertical post 130 rotating around its length where it connects to the plate 140. This rotation can also be accomplished by a ball joint where the vertical post 130 connects to the plate 140. At the pantograph point PP can be connected an extensible force element 132, such as an elastic band, spring element, or cord, that may be connected lower down to the plate 140. This spring element 132 creates a constant or near-constant downward force in a nearly-vertical direction on the pantograph point, thereby providing gravity compensation for the arm.

In this embodiment with the Y-fork 190, the arm balancing line L extends from the pantograph point PP through the center or near center of the Y-fork (where the three rotational axes intersect) to the arm support point SP, which is located near the center of the user's forearm. The Y-fork has distinct axes of rotation for the different shoulder degrees of freedom. Alternatively, a ball joint at the fulcrum point FP, as described in other embodiments, may provide the same. Similarly, a rigid link could be used to create a downward force at the pantograph point PP, connected by a ball joint or roll-pitch-roll joint. In this case, to create a downward force and allow the pantograph point PP to move upward and downward, a spring could be attached at the lower end of the rigid link.

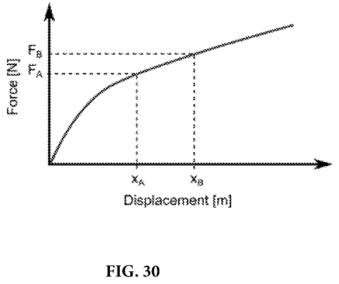

One way of generating a near-constant downward force, in accordance with an embodiment of the present invention, as one or both of the force elements 130 and 132, is to use a piece of rubber or a spring that has been pre-tensioned. As shown in FIG. 30, if a piece of rubber is pre-tensioned to have displacement x_{A}, and then during the operation of the pantograph member via exoskeleton or robot extends up to displacement x_{B}, then the force will vary between F_{A} and F_{B}. If a spring or piece of rubber is chosen to have a low initial stiffness then pre-tensioned a large amount, such that x_{A} is large, then the change in force will be relatively small as compared to a stiffer spring that has displacement that varies from x=0 to x_{B}.

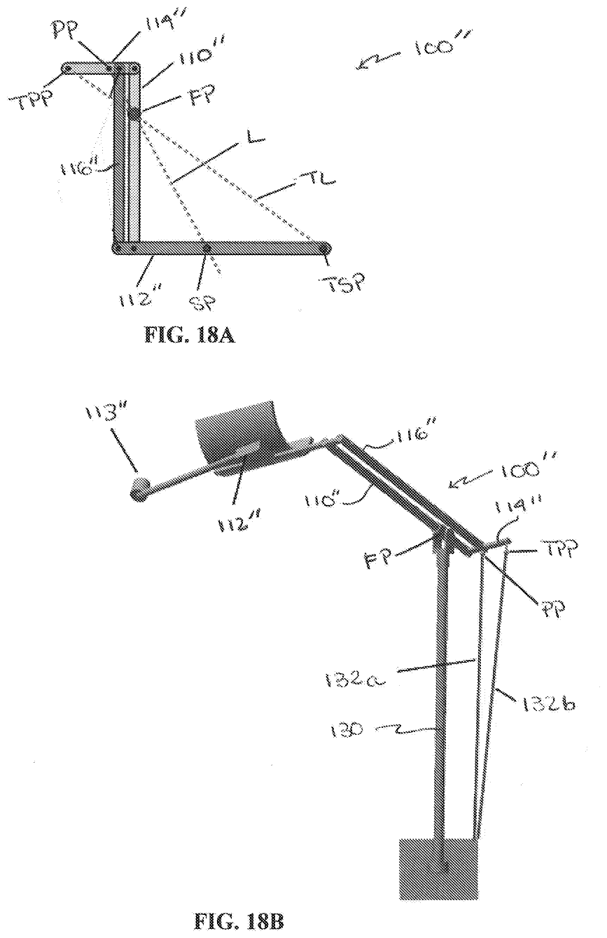

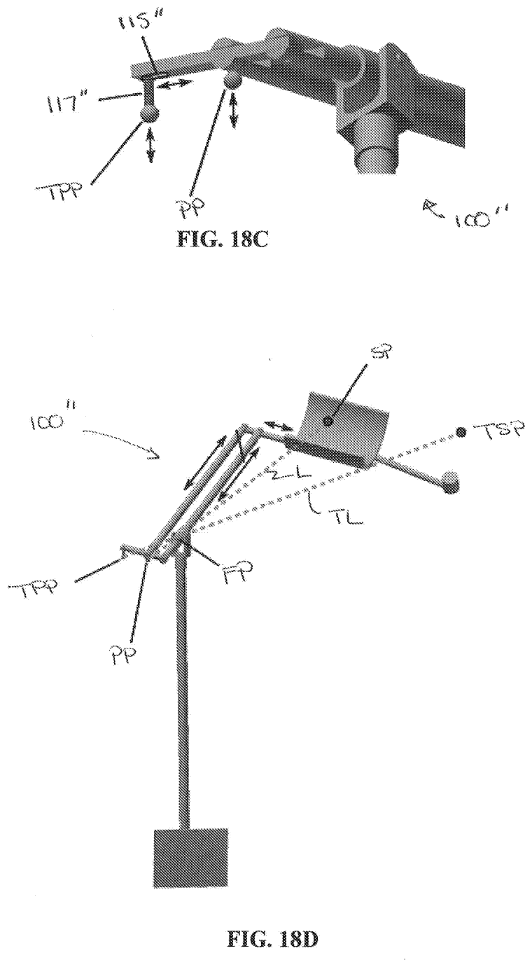

Referring to FIGS. 18A-18D, the present invention may also provide gravity compensation for a tool or other object held in or near a user's hand using a pantograph member 100″ with an intermediate fulcrum. As described above, there is a tool balancing line TL that extends from the user's shoulder to the center of mass of the tool. This tool balancing line TL intersects the pantograph arm or connector link 114″ at more distal point from the body than the arm balancing line L described above. This intersection point with the link 114′ is the pantograph point TPP for the tool. As seen in FIG. 18A, the connector link 114′ is elongated as compared to the connector link of the previous embodiments and is pivotally connected to main link 110″ and four-bar link 116″.

In FIG. 18A, it can be seen that the tool pantograph point TPP duplicates the kinematics of the tool support point TSP. Because the fulcrum point FP is between the tool pantograph point TPP and the tool support point TSP, the tool pantograph point TPP can lift up when the actual tool moves down, or the tool pantograph point TPP can lower when the actual tool lifts up. And with a constant or near-constant force downward at the tool pantograph point TPP, the pantograph member 100″ remains balanced, similar to how a teeter-totter is balanced independent of orientation. A downward force at the tool pantograph point TPP can be used in conjunction with a separate downward force at the pantograph point PP to support both the arm and tool. The pantograph point PP and support point SP can be located to balance the weight of the arm plus pantograph mechanism, arm by itself, or pantograph mechanism by itself, for example, which can provide gravity compensation for the user if they are not carrying a tool. At the forearm link 112″, there could be an additional segment 113″ that extends from near the elbow to the hand, where it can connect to a tool or payload. This attachment point could be a hook or other structure designed to lift boxes or objects with handles, or, for example, a drill or other hand tool could clamp on to the exoskeleton structure there. The segment 113″ extending to the hand could connect to the structure with a forearm roll joint.

With this tool embodiment, a mass at the hand can be independently controlled from the mass of the arm. The force elements or spring elements 132a and 132b (FIG. 18B) can be connected to the pantograph point TPP for the tool and to the pantograph point PP for the combined mass of the arm and exoskeleton, and can be independently connected or disconnected, or have their force varied. For example, once the user puts on the exoskeleton, the user may decide to provide gravity compensation for the weight of their arm. To do this, force can be created in the arm cable or spring element 132b. Then, if the user picks up a heavy box or tool, the user may decide to have gravity compensation for the box or tool. To do this, force can be created in the tool cable or spring element 132a, and the force can be adjusted to compensate for the mass of the box or tool. The force element 130 may be connected to the fulcrum point FP. Alternatively, a simpler overall exoskeleton design may be to not include force element or spring element 132a at all, and thus the exoskeleton would only support the weight of a tool and would not support the weight of the wearer's arm or the exoskeleton itself. This may be advantageous if the exoskeleton is very light.

All of the exoskeleton designs and embodiments of the present invention may need to be adjusted to fit different sizes of user, or different locations of a tool or box relative to the user's hand. These adjustments can be accomplished both at the pantograph arm and along the exoskeleton itself, as seen, for example, in FIGS. 18C and 18D. Also the length of the force element 130 can be adjusted to match the distance between a user's waist and their shoulder.

The tool pantograph point TPP can be adjusted in order to make the tool balance properly if the center of mass of the tool is not located close to the hand. For example, if the tool's center of mass is above the hand, then the tool pantograph point can be moved downward from the pantograph arm 114″. Or, if one user has a shorter forearm than another, the tool pantograph point TPP can be moved closer to the main link 110″. Both of these adjustments can be accomplished by providing a slot 115″ in the pantograph arm 114″ can such that the tool pantograph point TPP can be connected to this slot 115″, such as via a threaded post 117″, for example, as seen in FIG. 18C. Nuts can be attached to the threaded post 117″ on either side of the pantograph arm 114″ so that the distance the post 117″ extends away from the pantograph arm 114″ can be adjusted. Similarly, if the nuts are loosened then the threaded post 117″ can be moved along the slot 115′, to correspond and adjust to different lengths of a user's forearm. The pantograph point PP for the arm can be adjusted in a similar way.

In an alternative embodiment, the tool may be fixedly attached to the pantograph member exoskeleton, either rigidly or through a gimbal mechanism, so its position remains approximately constant with respect to the forearm. In this embodiment, the tool acts as part of the forearm and hand segment. A single pantograph point can be used to provide gravity compensation to the entire arm plus tool. To achieve this, the same procedure can be used to find the location of the balancing line, except that now the mass of the tool goes into the calculation of the forearm plus hand mass. This will result in a balancing line that is shifted toward the hand relative to a line that did not have a fixed tool on the end.

The pantograph member exoskeleton itself can also be adjustable for different sizes of the user. The arrows in FIG. 18D show locations where the exoskeleton can be adjusted. These adjustments could be accomplished, for example, by having each of the links (with an arrow next to it) comprised of two segments that can overlap for some portion of their length. For example, each link 110″, 112″, and 116″ of the pantograph member 100″ could be composed of two tubes, where one has a smaller diameter (inner tube) than the other (outer tube). The inner tube could fit inside the outer tube, so that the tubes can slide to elongate or shorten (i.e. telescope). Then, the two tubes could be clamped together to secure them to each other and fix their total length. Or, the outer tube could have a series of holes in it, and the inner tube could have a spring-loaded protruding pin that could fit into the holes. An appropriate hole could be chosen to match the total tube length to that of the user's arm. Instead of tubes, flat plates could also be used. For example, each link 110″, 112″, and 116″ could be comprised of a lower plate and an upper plate. The upper plate could have a slot in it along its length, and the lower plate could have holes in two locations along its length. Bolts could extend through the holes in the lower plate and through the slot in the upper plate and secured with a nut. If the nut is tightened, the plates will hold their position relative to each other, but if the nuts are loosened then the plates can slide along their length to shorten or lengthen the entire assembly. Any of the multiple or four-bar linkage embodiments disclosed can be adjusted in a similar manner.

While the fulcrum point FP can be mounted more or less directly above the vertical connector or beam 130 that transfers the force to the wearer's waist, as seen in FIG. 18D, in general the fulcrum point FP could be mounted to other components. For example, there could be a vertical connector or beam in the center of the wearer's back, and then a series of horizontal links connected by pin joints with their axes in the vertical direction. The collection of these horizontal links could extend sideways from the center of the user's back to behind their shoulder, where one link connects to the vertical beam and then a second link connects its near side to the end of the first link, and a third link connects its near side to the end of the second link, and so on. The end of the last link, which would be positioned next to the shoulder, could be connected just under a Y-fork, for example, or in general could connect to the fulcrum point. This could allow the user's shoulder to move in a more natural way.

For any of the disclosed embodiments, additional springs can be placed at any of the joints of the pantograph member to bias an individual joint in one direction. This may be useful for stroke patients, for example, who may have trouble extending their elbow. In this case, a torsional spring at the elbow of the pantograph member could extend the arm, or a linear spring between two parts of the structure could extend the arm instead. Or, a spring could be used at the pantograph point PP or tool pantograph point TPP to bias the arm or tool either toward the body or away from the body. This may be useful, for example, if the user would like a heavy tool to move toward their torso when they relaxed. This may allow the user to operate the heavy tool more safely.

Alternatively, the cables or force elements connecting to the pantograph arm could be attached at different locations than the pantograph points in order to create a gravity compensation force. Specifically, it could be possible to connect cables, spring elements, or other force elements to a point on the pantograph arm slightly below the nominal location of the pantograph point along the arm balancing line or tool balancing line, for example in the class 1 lever system. This would cause the arm to preferentially remain horizontal, with additional effort required to accomplish shoulder roll. Similarly, it would be possible to move the position of the lower end of a cable, spring element, or force element connecting to a pantograph point in a class 1 lever system, in order to create forces in one direction. For example, if the force element was not vertical but had its end at a 45 degree angle with respect to the pantograph point, this would cause the pantograph arm to be pulled toward the body, for example, which would in turn pull the exoskeleton arm toward the body. This may be useful if, for example, the user has their torso at an angle with respect to vertical. Similar things can be done with the disclosed class 3 lever system.

Both class 1 or class 3 lever pantograph mechanism can be mounted either in front of or behind the human's arm, in the case of an exoskeleton. If the class 3 linkage is behind or directly in front of the shoulder, the gas spring moving up and down can approximate the motion of the scapula. In this case, the fulcrum point could be positioned proximal to the actual biological shoulder joint.

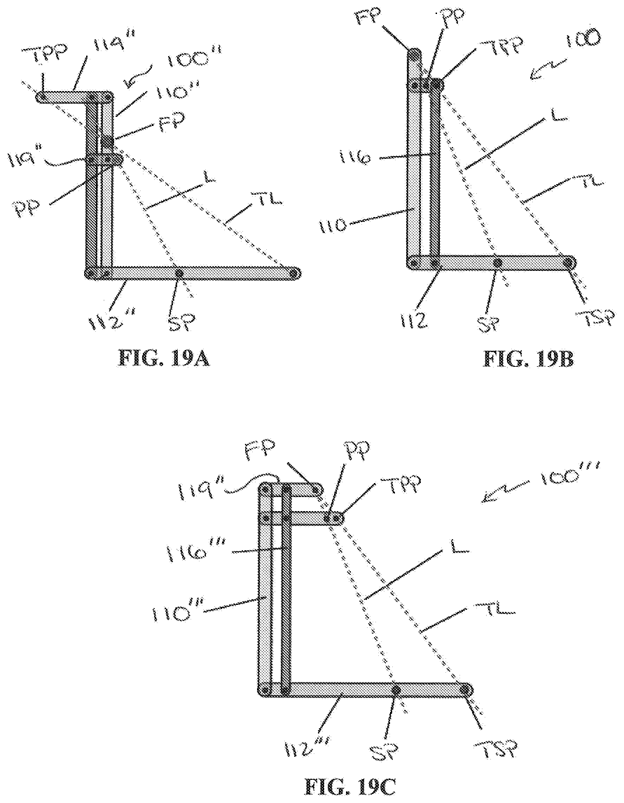

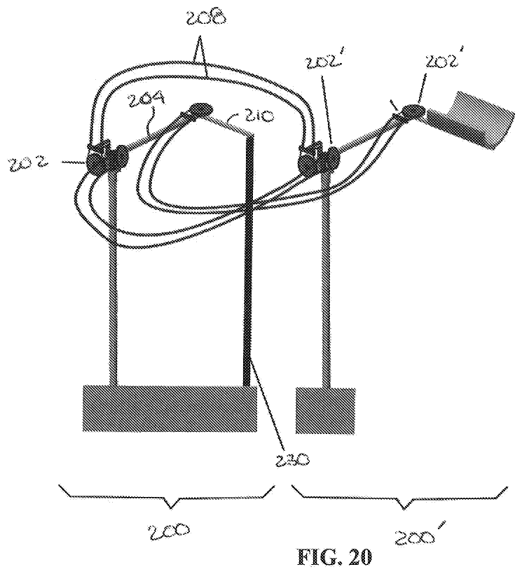

Referring to FIG. 19A, the pantograph mechanism 100″ may be a combination of a class 1 and class 3 lever. In this case, a secondary connector link 119″ may be used at the fulcrum point FP of the pantograph member to create an upward force, so that if either the tool pantograph point TPP or arm pantograph point PP have forces on them, the pantograph mechanism will remain in place on the arm. Alternatively, the pantograph mechanism 100 of the present invention may have the arm pantograph point PP and tool pantograph point TPP which both use a class 3 lever, as seen in FIG. 19B. Also, when the pantograph linkage mechanism is supporting an arm or a tool (not both), then the fulcrum point FP and pantograph point PP can be interchanged, converting the class 1 lever to a class 3 lever or vice versa. For example, if the tool pantograph point TPP was not used, then the arm pantograph point PP could be the second point with an upward force and the fulcrum point FP could be the third point with a downward force.

In another embodiment, the pantograph mechanism 100′″ may have a fifth bar, i.e. a 5-bar linkage in which the fulcrum point FP may not be co-located with the main link 110′″ or four-bar link 116′″, as seen in FIG. 19C. In this embodiment, the fulcrum point FP can be on a secondary connector link 119′″ that can rotate to be parallel or substantially parallel with the forearm link 112′″ on account of the main link 110′″ and four-bar link 116′″ connecting the links 112′″ and 119′. The main link 110′″ and four-bar link 116′″ can be out of the way of the fulcrum point FP and pantograph points PP, which may be useful so the exoskeleton or robot has a different form factor due to space constraints. If this mechanism is an exoskeleton, one or more cuffs for the upper arm could be attached any number of places, including on the four-bar link, on the link connecting the pantograph points to the main link, or on another link entirely that is connecting to both the four-bar link and main link. The arm cuff could be attached to any of these locations with a pivot joint, so it can rotate with an axis parallel to the pin joints in the drawing.

In general, any number of parallel or substantially parallel multiple-bar linkages can be used to connect the fulcrum point FP, pantograph point PP, and support point SP, as long as the motion of the pantograph point PP generally mirrors or duplicates that of the support point SP and the motion of the arm.

Referring to FIG. 20, an alternate way to implement a pantograph mechanism in accordance with the present invention, is to use pulleys and cables. To achieve the pantograph to mimic the arm's motion, a similar structure as those discussed above can be configured with cables and pulleys. For example, at each joint of the pantograph member 200, a pulley 202 can be connected to the distal end of a link 204 and a block or the like can be connected to the proximal end of the link 204. Cables 208 can extend to each pulley 202, where the cable wraps around the pulley 202 and then terminates into the pulley. In this way, if the joint moves in one direction, one of the cables is pulled out of the pulley and the other one is pushed toward or into the pulley. In an embodiment, cables 208 from a first mechanism (e.g. the pantograph member 200) can be connected to the pulleys 202′ in a second mechanism (e.g. an exoskeleton or robot arm 200′) so that the pantograph member 200 moves in the same way as the exoskeleton or robot arm 200′. Alternatively, one or more of the pulleys may be configured so that the pantograph member 200 moves in the opposite direction of the exoskeleton 200, such as if certain space constraints exist. At the arm support point SP on the main or pantograph arm 210, a spring element 230 is connected that can provide a near-vertical force to the support point on the pantograph arm. Due to the connection via the cables 208, this will provide an upward force on the exoskeleton or robot arm 200′ at that point. Instead of cables, a hydraulic system that functions similarly could be used.

In the embodiment of FIG. 20, the pantograph member 200 may be substantially identical in size to the exoskeleton 202′. In that case, the upward force on the pantograph arm support point SP can be generally equal to the upward force that will be generated on the exoskeleton arm support point SP′. The pantograph member 200 can also be made smaller in size than the exoskeleton 202′. In that case, the link lengths on the pantograph member 200 can be scaled down by some factor, and the upward force provided by the spring element 230 can be scaled up by that same factor. The pulleys 202 can be the same diameter on the pantograph arm 210 and exoskeleton 202′, so that the links move symmetrically or generally symmetrically. A smaller pulley diameter could be used in combination with a gearbox to generate the same angular change for the exoskeleton 202′ and pantograph member 200. The exoskeleton arm can have a vertical rotation degree of freedom, similar to the embodiments above.

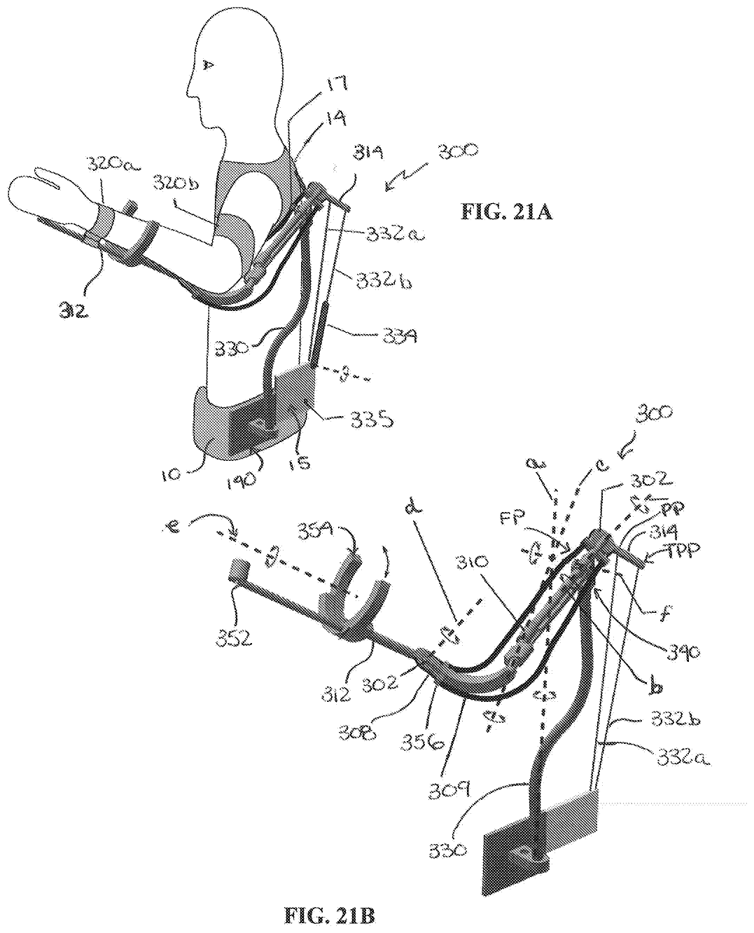

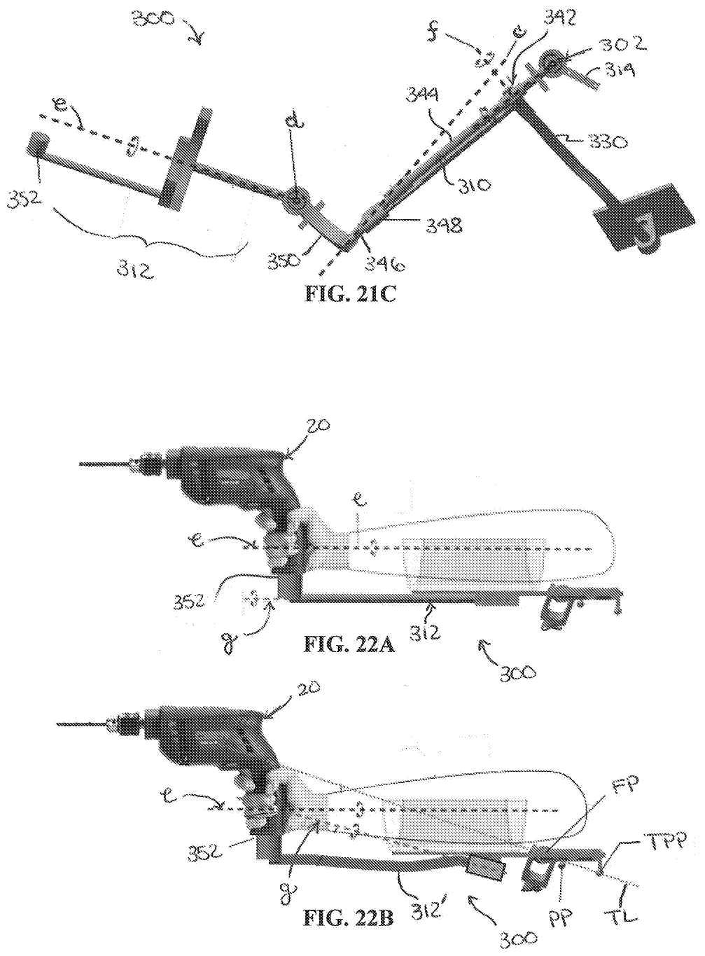

Referring to FIGS. 21A-21C, in another embodiment, a pantograph mechanism 300 of the present invention can use a combination of pulleys and linkages, which may allow the mechanism to better align with the user's biological joints. Pantograph mechanism 300 generally includes a main link 310, a forearm link 312, and a pantograph arm or connector link 314. As seen in FIG. 21A, at the bottom of the mechanism there can be a plate 15 for attaching to the waist belt 10, for example. Extending upward from another fixture, e.g. plate 140, can be a vertical connector or post 330, which may be curved. The vertical post 330 can be connected to the plate 140 with a ball joint or the like, for example, to permit rotation about a vertical axis and also to permit some motion tilting in both directions, which can help the pantograph member stay aligned with the user when they bend or twist their torso. This post 330 may be bent so that the bottom portion of the post 330 may be located underneath the user's shoulder joint and the top portion of the post 330 may be located behind the user's shoulder. In other words, the curve of the post 330 allows the post to go around the side of user's body so that the axis of rotation a may be co-located with the shoulder joint, as best seen in FIG. 21A.

A top end of the vertical post 330 may be connected to the main link 310 via a Y-fork 340, for example, as seen in FIG. 21B, in a similar manner to that described above. The Y-fork 340 may be located at the same or nearly the same vertical height as the user's shoulder's center of rotation and behind the body. The Y-fork 340 holds a rotational joint 342 that can be the pantograph shoulder internal/external rotation joint axis b but does not have to correspond to any biological axis.

The main link 310 may include a shoulder lift beam or link 344 that extends from rotational joint 342 and connects to a circular beam or link 346, such as via a shaft coupler, for example, that may be at a slight angle with respect to the rotational joint, as seen in FIG. 21C. The circular beam 346 can rotate around an axis of rotation for exoskeleton shoulder internal/external rotation c, which coincides or generally coincides with the shoulder center of rotation. Circular beam 346 may connect to a rotational block 348 which can hold the circular beam 346 such that it can rotate around the axis of rotation for exoskeleton shoulder internal/external rotation c and rotate around its own axis. This circular beam 346 can in turn be connected to a curved elbow beam 350 that can drop down below the user's elbow joint. Curved elbow beam 350 can connect to the forearm beam or link 312, with the axis of rotation d passing through the user's elbow joint.

Forearm link 312 can have a track 354 for the user's forearm roll degree of freedom, as best seen in FIG. 21B. Track 354 may have, for example, two hemispherical elements that can be connected together so as to permit the distal hemispherical element to rotate about the center of the hemispherical arc defined by each element. This axis of rotation, that is the exoskeleton forearm roll axis e, is coincident or generally coincident with the human arm's axis of rotation. In this manner, the user can rotate their forearm and their hand can remain attached to a tool, which can be attached to the end 352 of the link 312, as seen in FIG. 22A. Thus, in this manner, the pantograph member's exoskeleton has joint rotation axes which align well with the biological joints in the arm, from the shoulder down to the forearm roll axis e.

The pantograph member 300 of FIGS. 21A-21C may be assembled by, for example, connecting the shaft within the rotational joint within Y-fork 340 to the pantograph arm 314 and to the circular beam 346 within the rotational block 348, such that the pantograph shoulder roll (internal/external rotation axis b) rotates to follow the exoskeleton's shoulder roll axis. To provide shoulder flexion/extension for the user, the joints on the pantograph member 300 may be connected via pulleys 302 with at least one pulley connected to the distal end of the pantograph arm 314 and another pulley to the proximal end of the curved elbow beam 346. A cable mount block 356 may be provided on circular beam 346 that can have two cables 308 extending therefrom to the pulleys 302 at the distal end of pantograph arm 314. The cable mount block 356 may also connect to two cable sheaths 309, which can extend back to a cable mount block on the pantograph member.

On the pantograph arm 314, there may be one or more elastic elements 332a or 332b, e.g. spring or cable elements, pulling downward at the locations corresponding to the arm pantograph point PP and/or to the tool pantograph point TPP, respectively, in a manner similar to the previously described embodiments.

In an embodiment, the axis of rotation for the pantograph shoulder internal/external rotation b (and the rotational joint within Y-fork) could be shifted along the axis of rotation for shoulder flexion/extension f for so that it is closer or next to the Y-fork 340. The horizontal jog in the curved vertical support beam 330 could be increased so that the Y-fork 340 can be closer or next to the rotational joint within Y-fork and the rotational joint within Y-fork can be cantilevered therefrom. This embodiment permits the range of motion around the axis of rotation for shoulder flexion/extension e to be increased. With the rotational joint beside the Y-fork, a full range of motion (that is +/−90 degrees) is possible.

FIG. 21A illustrates one exemplary way of wearing the pantograph member 300 of FIGS. 21A-21C or the exoskeleton thereof. One or more cuffs 320a may be provided on the forearm link 312 to connect the user's arm to the distal portion of the forearm link 312. There can also be another cuff 320b on the main link 310 connected to the rotational block 348 on the upper arm. There could also be a cuff on the proximal portion of the forearm link. These cuffs 320a and 320b can be a textile structure, strap, or the like, or a rigid arm cuff in conjunction with a strap or textile, as described in other embodiments. Also, the shoulder and/or chest harness 14 can be used to secure the pantograph member exoskeleton to the user's torso. The harness 14 can be connected to the exoskeleton, such as via a tether 17 at a variety of locations, such as at the Y-fork 340 or pantograph arm 314. An elastic element or strap (not shown) may be provided that connects the Y-fork or pantograph link to the opposite shoulder to help the exoskeleton remain in place as the user moves around.

As seen in FIG. 21A, a rotational link 334 may be provided as an exemplary way of engaging or disengaging the force from the exoskeleton pantograph member 300. Rotational link 334 may connect to a bottom portion of one of the spring/elastic elements 332a or 332b and connect to the waist belt 10, plate 15, or to a lower position on the vertical support beam 330. The rotational link 334 can be configured to rotate with respect to an axis of rotation f (FIG. 21A) and configured to move up and down. When rotational link 334 is rotated and moved upward, the elastic element 332a or 332b connected thereto is shortened such that force produced by the elastic element decreases to have a low force or zero force. When the rotational link is rotated and moved downward, the elastic element 332a or 332b connected thereto stretches such that its force is increased. The rotational link 334 can rotate until it hits a hard stop 335, for example, which would prevent it from further rotation. The hard stop 335 could be positioned past the line that is in-line with the elastic element 332a or 332b, so that the force from the elastic element 332a or 332b presses the rotational link 334 against the hard stop 335 (i.e. the rotational link is over-centered). Or, the rotational link 334 could be held in a downward configuration with a latch or clip (not shown). When the rotational link 334 is in the upward position, the elastic element 332a or 332b above it is not extended, and thus has a decreased or no force. When the rotational link 334 is in a downward position and is pushed against the hard stop 335, the elastic element 332a or 332b is pre-tensioned to pull down on the pantograph arm 314.

Referring to FIGS. 22A and 22B the pantograph mechanism 300 can support a tool 20, such as a power drill. The balancing line TL for the tool or payload intersects the tool center of mass, the pantograph point TPP for the tool, and the fulcrum point FP. The forearm link 312 may be coupled to the elbow joint of the pantograph member via a rotational joint, thereby defining a rotational joint axis g. The rotational joint axis g may be generally parallel to the axis of rotation of the forearm e, as seen in FIG. 22A. Alternatively, the rotational joint axis g can be angled, e.g. less than a 45 degree angle, with respect to the axis of rotation of the forearm e, such that the rotational joint axis g can pass through the user's wrist or hand, as seen in FIG. 22B. The forearm link's axis of rotation e may pass through the user's wrist no matter how they rotate their wrist in wrist roll. To accomplish this, the forearm link 312′ can be curved, as seen in FIG. 22B, so as to not intersect the forearm when the wrist rolls. A cuff may be connected to the forearm link 312 such as close to the elbow joint. At the distal end 352 of forearm link can be the connection point for the tool, handle, or other element, that the user can hold or grasp. When the user rotates their wrist, the forearm link rotational axis e intersects with the user's wrist or hand, which allows the user to rotate their hand while grasping the tool or handle.

This mechanism for wrist alignment can be applied to any exoskeleton and joint of any of the pantograph member of the present invention which has three degrees of freedom. The rotational axis of a shoulder joint can be angled to intersect with the shoulder joint's center of rotation, as described in the embodiments above. Similarly, a leg exoskeleton can have a rotational axis for the ankle along its length (external/internal rotation) that is not parallel to the shank but instead intersects the user's ankle joint or a point just distal to the ankle joint. Such an axis would be at a shallow angle (<30 or 45 degrees) with respect to the axis along the shank. A leg exoskeleton can also permit hip internal/external rotation by having a rotational axis that passes through the center of the biological hip ball joint, and then have two other rotational axes for flexion/extension and abduction/adduction.

In general, the embodiments described here include the pantograph mechanisms and forces on the pantograph members thereof so that there is an upward force at the support point SP and a possible second upward force on the tool at tool support point TSP. This can be done with two downward forces with a class 1 lever pantograph (one at the arm support point, one at the tool support point) or two upward forces with a class 3 lever pantograph (one at the arm support point, one at the tool support point). However, in general more upward or downward forces can be used. Considering the class 1 lever pantograph member, for example, it is possible to provide a downward force on the pantograph linkage at two or more locations to provide gravity compensation for the user's arm, and an optional additional force to provide gravity compensation for the tool. One force can provide gravity compensation for the mass of the upper arm, and a second force can provide gravity compensation for the mass of the forearm plus hand. Or, the second force could provide gravity compensation for just the mass of the forearm, and a third force could provide gravity compensation for the mass of the hand. An extra force could provide gravity compensation for the tool in each of these cases. Similar things can be done with the class 3 lever pantograph member. These forces could be positioned on the pantograph arm in the corresponding locations to the locations of masses on the actual arm. It would also be possible to, for example, divide the mass of the user's upper arm into two segments. Each of these segments has its own center of mass. A force could be created on the pantograph arm for each of these two segments, thus having two separate forces for just the upper arm. This could be implemented by having multiple cables attached to the pantograph linkage pulling down (in a class 1 lever pantograph) or multiple upward forces from spring elements or other mechanisms in a class 3 lever pantograph.

Encoders or other sensors can be added to any of the embodiments, exoskeletons or robots of the present invention to determine the position of the links of the pantograph mechanism. For example, in a rehabilitation context, the user's motion can be monitored to detect if user is improving. Sensors could include, for example, Inertial Measurement Units placed on the upper arm or forearm links, or potentiometers placed at each joint of the pantograph member links.

Any of the pantograph mechanism embodiments could be mounted to a table or fixed surface, or mobile base, for users sitting in a chair. The user would not need to put on an exoskeleton, but could move into place, for example, if the user was doing rehabilitation therapy or was using a tool that was in a fixed location with respect to a work cell. The user could strap their arm to the pantograph mechanism or could hold onto a handle or other interface near the hand. The vertical force from the arm and/or tool may be transferred to the ground, or to a lower body exoskeleton instead of to the wearer's waist. This would reduce the forces on the wearer. A vertical beam, for example, may be connected to the wall mount through a pivot that only permitted rotation about a vertical axis. A hinge could be used to connect a vertical support to the ground so that the mechanism remains vertical at all times.

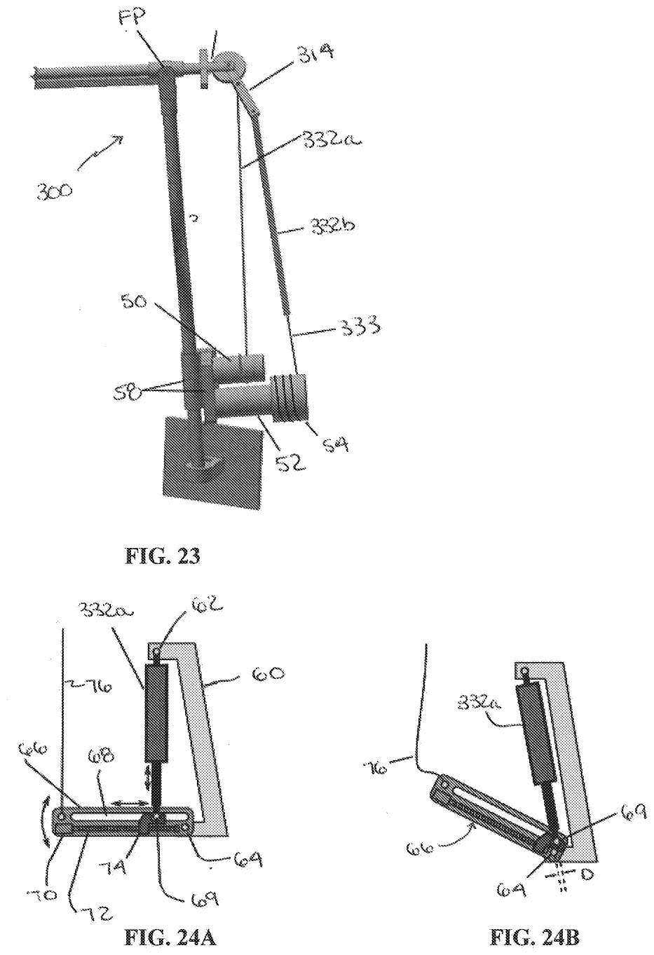

The present invention contemplates alternative ways of modifying the gravity compensation for either the arm or the tool embodiments by incorporating one or more motors. For example, FIG. 23 shows the spring/elastic elements 332a and 332b connecting to the pantograph member 300 (for an exoskeleton worn by the user or for a robot arm) at their upper ends. At the lower ends, the elastic may be wrapped around a drum 50, which can be connected to vertical beam 330 of the pantograph member. Drum 50 can be rotated manually or by a motor 52. If rotated manually, drum 50 can be locked in place with a latch or the like. This allows the tension to be created or released in the arm pantograph elastic, such as elastic element 332a or 332b, thereby changing the force to match the weight of a user's arm or to release it entirely so the exoskeleton can be doffed easily. It is also possible to have a short segment of the elastic element 332b connected to the tool pantograph point, and a cable or string 333 connected to the distal portion of the elastic element. This cable 33 or other flexible, inextensible element can wrap around the drum 50 instead of the elastic itself, which may lead to higher service life.

As seen in FIG. 23, a motor 52 and a pulley 54 (or drum) can also be attached to the vertical support beam 330, such as by one or more brackets 58. The pulley 54 can have a cable or flexible element wrapped around it, and the top end of the cable is connected to an elastic or spring element which in turn connects to the tool pantograph point. That allows the exoskeleton to modulate the tension in the elastic element in accordance with the weight of a tool, box, or other object that the user picks up. If a heavy tool or other object is lifted, the motor 52 can rotate to wind more cable around the drum 50, thereby stretching the elastic and increasing the gravity compensation force. If the user puts down a tool or object, the motor can rotate to create slack in the spring element and cable, thereby removing the gravity compensation force.

Either the user or the exoskeleton itself (in conjunction with sensors and a controller) can control the tension in either the arm gravity compensation spring element 332a or the tool gravity compensation spring element 332b in conjunction with motor 52. For example, the user could push a button (not shown) to rotate the motor which would in turn retract the cable and create more force in the spring element. Another button could be used to rotate the motor 52 in the opposite direction and release the force in the spring element. Alternatively, sensors in the pantograph member exoskeleton near the hand could detect the presence of a known tool mass. The pantograph system of the present invention can be calibrated to apply a preset force when a certain object is lifted. A sensor could detect the presence of that tool which would cause the controller to control the motor 52 to retract the cable the appropriate amount. For example, a tool could include a Bluetooth transmitter that identifies its mass. The tool could be connected to an interface on the exoskeleton, and a button could detect that the tool had been connected and could trigger the controller. The microcontroller could read the Bluetooth signal from the transmitter to identify the object, and thus determine the mass of the tool. It would then retract the cable appropriately to create more force on the spring element. Alternatively, a hook used to lift boxes could be located on the pantograph member exoskeleton near the hand. Sensors such as force sensors could detect the weight of an object pulling down on a hook, and in conjunction with a controller automatically turn a motor 52 to create the correct force in the spring element 332 to perfectly compensate for the weight of the object.

In another embodiment, the user could wear force sensors in their shoes or under the feet of a lower-body exoskeleton. These force sensors could detect the total downward force on the pantograph member exoskeleton wearer. If the average downward force through the feet was found to be larger than the wearer's body mass, for example when the user had both feet on the floor and was not walking, the exoskeleton could detect that the user was attempting to lift something and could then create an extra gravity compensation force to provide extra gravity compensation to the arm for supporting the tool.

FIGS. 24A and 24B illustrate an exemplary way of adjusting the force in the tool gravity compensation element or arm gravity compensation element of the present invention is shown. A frame 60 can be connected to the exoskeleton's waist belt 10 or to a vertical support bar, such as vertical bar 330. At the top of frame 60, a joint 62, such as a pin joint, can connect the frame 60 to a force element, such as a compression spring or gas spring, labeled element 332a in FIG. 24A. At the bottom of the frame 60, another joint 64, such as a pin joint, can connect the frame 60 to a lever arm 66. The lever arm 66 that may have a slot 68 therein such that the bottom of the elastic element 332a or 332b can be constrained to lie within the slot 68 such as via a sliding pin 69 in the slot 68. Also mounted on the lever arm 66 can be a motor 70 and gearbox. A screw 72, for example, can push a guide 74 back and forth along the length of the lever arm 66. The guide captures the sliding pin 69 at the bottom of the elastic element 332a or 332b, so that the position of the bottom of the elastic element 332a or 332b relative to the lever arm 66 can be controlled by rotating the motor 70. At the far end of the lever arm 66, a cable or spring 76 can extend vertically to either the arm or tool pantograph point of the pantograph member. The motor 70 can rotate the screw 72 and move the guide 74 to effectively change the radius of where the elastic element lies relative to the pin joint 64 connecting the frame 60 to the lever arm 66. Thus, if the radius is reduced, then there will be very little force on the cable 76 at the end of the lever arm 66. If the radius is increased, then there will be high forces on the cable 76. In this manner, the motor 70 can vary the force on the pantograph mechanism at the top of the cable. If the bottom of the force element 332a or 332b (e.g. compression spring) is pushed past the pin joint 64 connecting the lever arm 66 to the frame 60, then the lever arm 66 can rotate so as to create slack on the cable or spring 76, as seen in FIG. 24B, showing the gas spring 332a pushed past the pin joint 64 by a distance D. This can be useful to disengage the exoskeleton or if a user is not lifting a tool.

The mechanism of FIGS. 24A and 24B can be used without the motor 70 and screw 72, if the user manually moves the position of the bottom end of the force element 332a (e.g. compression spring) relative to the lever arm 66. This could be done, for example, to change the force on the arm pantograph point PP for different weights of user or to change the force on the tool pantograph point TPP for different fixed tool weights. The bottom of the elastic element 332a could be secured to the lever arm 66 with a nut and bolt, for example, which could be loosened to adjust the position of the elastic element. Alternatively, a curved track could be provided at the end of the lever arm 66 that could guide the cable or string. This could be used to create a constant radius from the pin joint at the proximal end of the lever arm 66, or to create a variable radius pulley so as to create a more constant force on the cable or spring. Also, the slot 68 can be configured to allow the elastic element to move to discrete positions and be easily adjustable by a user. At the bottom of the slot 68 can be protrusions and depressions, for example, so that the pin at the bottom of the elastic element, can settle into the depressions between the protrusions. At the top of the slot 68, spring-loaded protrusions can be provided which serve to help keep the pin 69 in one of the depressions at the bottom of the slot. However, a user could manually push the gas spring along the length of the slot by overcoming the restoring force from these protrusions.

In all embodiments, a motor can change the force on the tool or arm pantograph points TPP and PP even as the user moves their arm throughout their range of motion. If the force provided by a spring element is not constant, the motor can dynamically change the length of the elastic or spring elements. e.g. elastic elements 332a and 332b, (e.g. gas spring) so as to keep the force provided to the tool or arm pantograph points TPP and PP constant (or nearly so).

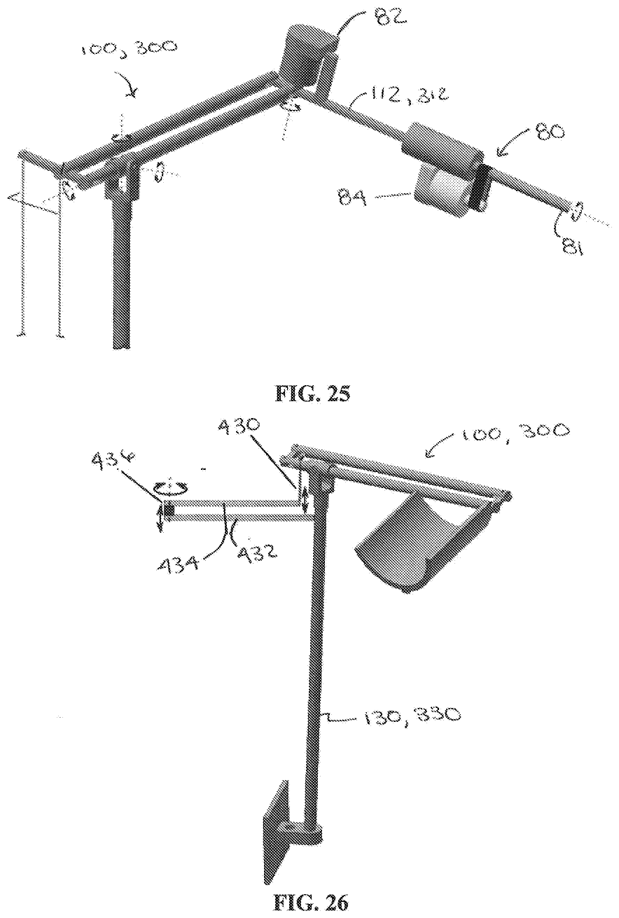

Motors may be placed in series or parallel with the structure of the pantograph member, such as seen in FIG. 25, to provide power to the joints thereof for a powered exoskeleton where the exoskeleton can provide trajectory assistance or help the user move, or to make a robot arm using this system for gravity compensation. In FIG. 25, a robot arm 80 is shown as an example in which a motor 82 can be at the elbow of the pantograph member, e.g. pantograph member 100 or 300, for driving the elbow degree of freedom and another motor 84 can be at the forearm link, such as forearm link 112 or 312, for driving the forearm roll degree of freedom. Motors could also be mounted to any of the other degrees of freedom of the pantograph member. A robotic wrist and hand 81 or other gripper can be positioned at the end of the forearm link 112. Motors can also be used with any of the embodiments of the present invention to provide power to one or more joints of the pantograph member.

The gravity compensation of the present invention used with a robot arm provides a human-safe system capable of lifting heavy payloads. The motors along the robot's arm would not need to lift the payload, but instead would just need to provide enough torque to accelerate the robot arm's inertia and the payload's inertia. The weight of the robotic arm and payload could be supported by downward forces on the pantograph points for the arm and payload, respectively.

Referring to FIG. 26, instead of the force element being a cable, spring, or elastic element for pulling vertically on the pantograph point PP, the force element can be other mechanisms that provide a downward force on the pantograph points in accordance with the present invention. For example, a short cable or cord 430 could connect to one or more leaf springs 432 and 434. One leaf spring 432 can connect to a vertical support beam, such as vertical beam 130 or 330, and also have a pivot 436 at its distal end. The pivot 436 can have a vertical axis and connect to the other leaf spring 434 that can extend back toward the pantograph arm, such as pantograph arm or link. The end of this leaf spring 434 can connect to the pantograph point or points with the cable or cord 430 or other inextensible element. The leaf springs 432 and 434 can bend upward to provide a downward force on the cord 430 and pantograph point PP. The pivot 436 may be in between the two leaf springs 432 and 434 to allow for the end of the first leaf spring 432 to remain below the pantograph point PP, even as the pantograph point changes its position as projected into the horizontal plane. Alternatively, a leaf spring could push down on the top of the pantograph point to provide a similar downward force.

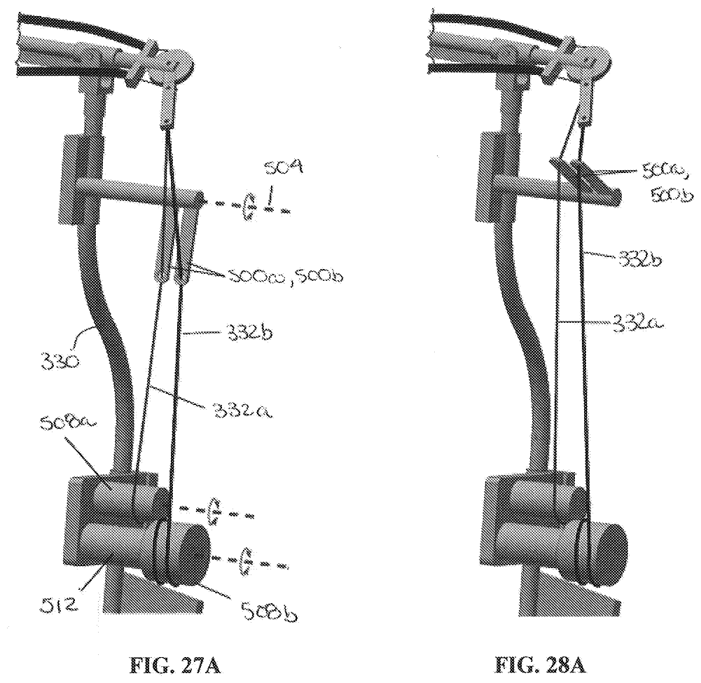

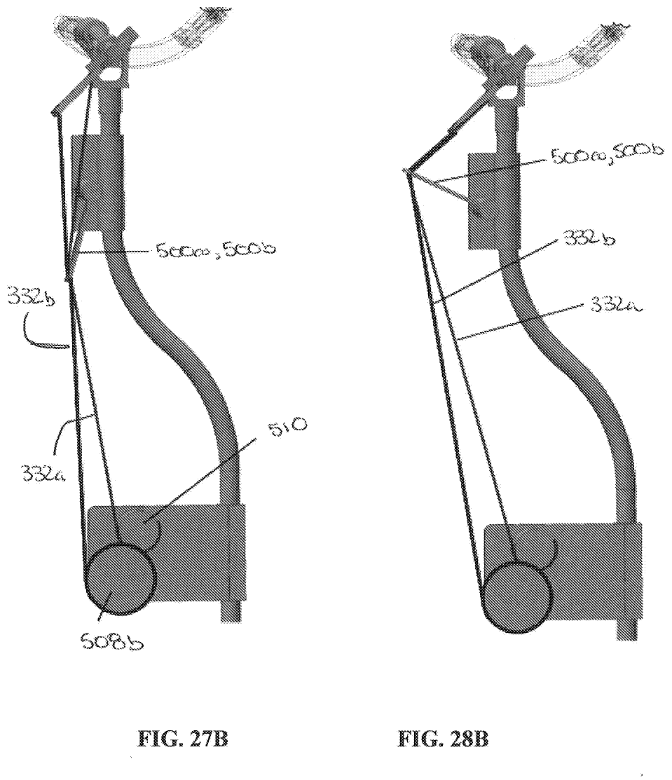

Referring to FIGS. 27A, 27B, 28A, and 28B, the direction of gravity compensation (or direction of the force on the pantograph arm) can also be varied during the operation of the pantograph member 100, exoskeleton or humanoid robot, in accordance with the present invention, to allow the exoskeleton wearer or humanoid robot to tilt their torso forward or backward, such as to bend forward to lift an object from the floor. When this happens, the gravity compensation system of the present invention may push the exoskeleton in the direction generally parallel to the wearer's torso. If a user or robot is bent forward 90 degrees or around 90 degrees, for example, this will push the arm forward instead of vertically against gravity. To account for this, the location of the lower end of force extension elements 132 connected to the pantograph member can be controlled to pull in the correct direction.

As seen in FIGS. 27A and 28A, two cable guides 500a and 500b (one for each of the arm and tool gravity compensation force elements or cables 132) may be provided that can have holes in them through which the cables 132 pass (or pulleys over which the cable can pass). Cable guides 500a and 500b can be connected to the vertical support beam 130 through an arm 502 and spool structures 508a and 508b. When the cable guides 500a and 500b are rotated in different directions via a rotational axis 504 of the arm 502, the cable guides move relative to the pantograph arm 114, thereby pulling the cables in different directions.

As seen in FIGS. 27A and 27B, the guides 500a and 500b can be rotated into a downward position, thereby pulling the elastic elements 332a and 332b nearly vertically. As seen in FIGS. 28A and 28B, the guides 500a and 500b can be rotated into an upward position, thereby pulling the elastic elements 332a and 332b outwardly to pull the pantograph arm away from the user's body. In this geometry, the user's arm is being pushed away from the body, which can assist a user or robot in doing such activities as push-ups, or to compensate for gravity if the user or robot has their torso tilted backward, if they were lying on their back, for example. If the guides 500a and 500b were to rotate about the rotational axis 504 to pull the elastic elements 332a and 332b toward the body, this can provide appropriate gravity compensation if the user of the pantograph member exoskeleton or humanoid robot tilted its torso forward. The rotation of the guides 500a and 500b could be controlled by a motor, in order to dynamically change the direction of the pull force, or it could be rotated manually. The elastic elements 332a and 332b may be inextensible such that the spring force for the gravity compensation is generated by torsional springs 510 (FIGS. 27B and 28B). Spools 508a and 508b can be mounted near the bottom of the vertical support beam 330 and are configured to allow the elastic elements 332a and 332b to wrap therearound, respectively. For the tool gravity compensation cable, a motor 512 can be mounted between the vertical support post 330 and the torsional spring 510, thereby creating a series elastic actuator. The motor can rotate to create pre-tension on the elastic elements 332a or 332b in conjunction with the torsional spring 510.

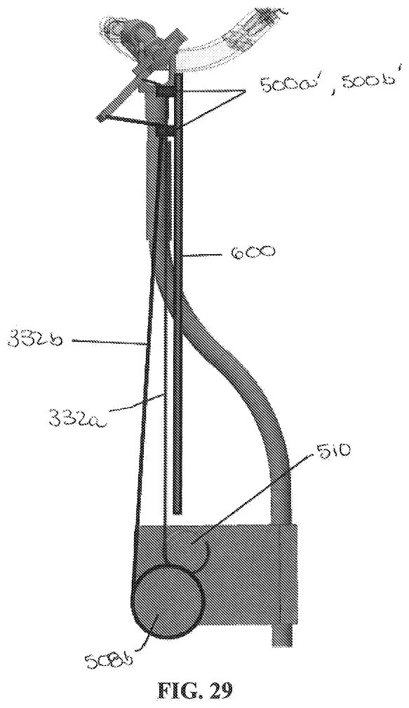

FIG. 29 illustrates an alternative way of changing the direction of gravity compensation in accordance with the present invention. Cable guides 500a′ and 500b′ can be mounted to a vertical track 600, which can be straight or curved, such that the cable guides can move up and down on the track 600. Guides 500a′ and 500b′ can be connected to the track 600, such as by a screw. A motor may be provided in association with the cable guides 500a′ and 500b′ to control the position of the guides along the track 600. In this embodiment, the cable guides 500a′ and 500b′ can be moved high up on the track 600 in order to pull the cables 132 toward the body, which can provide gravity compensation if the user or robot tilted their torso forward. The guides 500a′ and 500b′ can also be moved to the bottom of the track 600, which would then position the elastic elements 332a and 332b nearly vertical and provide gravity compensation if the user or robot had an upright torso.

In the class 3 lever gravity compensation mechanism, a similar method could be used to change the direction of force on any force element connected to the fulcrum point FP. Also, motors could also be connected to the bottom of the vertical spring (e.g. gas spring) in the class 3 lever system, which would create a horizontal force (in either of the two possible directions) on the pantograph point PP, which would in turn pull the arm in a different direction besides vertical.

Any of the embodiments disclosed in this document can be used in combination with each other as well as in isolation. It should be understood that terms such as “lateral,” “medial,” “distal,” “proximal,” “superior,” and “inferior” are used above consistent with the way those terms are used in the art. Further, these terms have been used herein for purposes of explanation and should not be considered otherwise limiting. Terms such as “generally,” “substantially,” and “about” are not intended to be boundaryless terms and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A gravity compensation mechanism for an arm, an arm holding a tool, or a tool comprising:
a pantograph member configured to mimic the kinematics of the arm, the pantograph member comprising a first point that is a support point for supporting the arm, the arm holding the tool, or the tool, a second point that is an upward force point where an upward force is applied to the pantograph member, and a third point that is a downward force point where a downward force is applied to the pantograph member, the first, second, and third points being axially aligned with one another along an arm balancing line,
wherein the second point is between first and third points such that torque is created in the pantograph member which transfers lift to the first point against gravity.

2. The gravity compensation mechanism of claim 1, further comprising a first force element coupled to the pantograph member at the second point and a second force element coupled to the pantograph member at the third point.

3. The gravity compensation mechanism of claim 2, wherein the first and second force elements are passive elements.

4. The gravity compensation mechanism of claim 3, wherein one or both of the first and second force elements comprises a spring element.

5. The gravity compensation mechanism of claim 2, wherein the first and second force elements are coupled to the pantograph member at upper ends thereof, respectively.

6. The gravity compensation mechanism of claim 2, wherein first force element comprises a spring member that applies the upward force to the second point.

7. The gravity compensation mechanism of claim 6, wherein the spring member is a gas spring, a leaf spring, or a spring biased post.

8. The gravity compensation mechanism of claim 2, wherein the second force element comprises a vertical connector.

9. The gravity compensation mechanism of claim 8, wherein the vertical connector is a spring element, rod, beam, cable, or cord that applies the downward force to the third point.

10. The gravity compensation mechanism of claim 2, wherein each of the first and second force elements is coupled to a user's body associated with the arm via an attachment device.

11. The gravity compensation mechanism of claim 10, wherein the attachment device is a strap, belt, band, or harness.

12. The gravity compensation mechanism of claim 10, wherein the first force element is coupled to the body at a lower end remote from the pantograph point of the pantograph member.

13. The gravity compensation mechanism of claim 2, wherein the pantograph member comprises at least a main link, a forearm link, a connector link, and a fourth link connecting the forearm and connector links, and the links are configured to pivotally cooperate with one another to mimic the kinematics of the arm.

14. The gravity compensation mechanism of claim 13, wherein the second point is located at or near an end of the connector link opposite a pivot connection of the connector link with the fourth link, the third point is located at an end of the main link opposite a pivot connection of the main link with the forearm link, and the first point is located on the forearm link, and wherein the connector link is pivotally connected to the main link.

15. The gravity compensation mechanism of claim 13, wherein the links of the pantograph member are bars, beams, cables, or combinations thereof.

16. The gravity compensation mechanism of claim 13, wherein the links of the pantograph member are pivotally connected via pin joints, ball joints, cable pulleys, or combinations thereof.

17. The gravity compensation mechanism of claim 13, wherein the pantograph member includes one or more vertical risers at one or both of the pantograph and fulcrum points.

18. The gravity compensation mechanism of claim 13, wherein the first and second force elements are coupled to the pantograph member at the second and third points, respectively, by a ball joint, roll-pitch-roll joint, roll-pitch-yaw-roll joint, or hinge joint.

19. The gravity compensation mechanism of claim 13, wherein one or more of the links have an adjustable length.

20. The gravity compensation mechanism of claim 2, wherein a motor is coupled to one or both of the first and second force elements.

21-32. (canceled)
